(19) United States
(12) Patent Application Publication
(10) Pub. No.: US 2025/0107630 A1
(43) Pub. Date: Apr. 3, 2025

(54) PRESSURE PAD COUPLING SYSTEM AND METHOD

(71) Applicant: Cross Innovations LLC, Cheyenne, WY (US)

(72) Inventor: Shawn P. Higgins, Cheyenne, WY (US)

(21) Appl. No.: 18/980,421

(22) Filed: Dec. 13, 2024

Related U.S. Application Data
(63) Continuation-in-part of application No. 18/521,516, filed on Nov. 28, 2023.

(30) Foreign Application Priority Data
Sep. 21, 2023 (CN) 202322577987.0

(51) Int. Cl. A47C 21/02; A47C 27/08; A47C 27/10

(52) U.S. Cl. CPC A47C 21/026; A47C 27/083; A47C 27/10

(57) ABSTRACT

A method of coupling a pressure pad system to an article that includes disposing a pad body of the pressure pad system on the article, the pressure pad system including first and second ends and first and second peripheral sides, the pressure pad system comprising: a plurality of end coupling tabs extending from one or both of the first and second ends, a plurality of peripheral coupling tabs coupled to the first and second peripheral sides, and a plurality of coupling straps. The method further includes coupling the pressure pad system to the article including wrapping at least two of the plurality of coupling straps around a portion of the article.

### CROSS-REFERENCE TO RELATED APPLICATIONS

This application is a Continuation-In-Part (CIP) of and claims the benefit of U.S. Non-Provisional application Ser. No. 18/521,516, filed Nov. 28, 2023, entitled “FLOCKED ALTERNATING PRESSURE PAD SYSTEM AND METHOD FOR BEDSORE PREVENTION,” with attorney docket number 0122777-001US0. This application is hereby incorporated herein by reference in its entirety and for all purposes.

This application also claims the priority to Chinese Patent Application No. 202322577987.0, filed Sep. 21, 2023, entitled “A multi chamber inflatable mattress.” This application is hereby incorporated herein by reference in its entirety and for all purposes.

### BRIEF DESCRIPTION OF THE DRAWINGS

FIG. 1 is an example perspective view illustrating an embodiment of alternating pressure pad.

FIG. 2 is another example perspective view illustrating an embodiment of alternating pressure pad.

FIG. 3 is an example front view illustrating an embodiment of alternating pressure pad.

FIG. 4 is an example cut-away perspective view illustrating an embodiment of alternating pressure pad.

FIG. 5 is an example side view illustrating an embodiment of alternating pressure pad.

FIG. 6 is an example diagram illustrating an embodiment of an alternating pressure pad system.

FIG. 7 illustrates a user lying on an alternating pressure pad on a bed that includes a mattress and a bed frame.

FIG. 8 illustrates a user sitting on an alternating pressure pad in a recliner that includes one or more cushions, a recliner body that includes arms and a back, and footrest.

FIG. 9 illustrates a pressure pad system disposed on a recliner that includes one or more cushions, a recliner body that includes arms and a back, and footrest.

FIG. 10a illustrates an example of a recliner with a footrest in an extended configuration.

FIG. 10b illustrates an example of the recliner of FIG. 10a with the footrest in a retracted configuration.

FIG. 11 illustrates an example embodiment of a coupling bag that defines a bag cavity in which the pad body of an alternating pressure pad can be disposed.

FIG. 12 illustrates another embodiment of a coupling bag that comprises a bag zipper disposed along a central length axis extending from a first end to a second end.

FIG. 13a illustrates an example of a peripheral coupling tab that is coupled to an edge of a coupling bag at an angle of 25 degrees.

FIG. 13b illustrates an example of an end coupling tab that is coupled to an edge of a coupling bag at an angle of 90 degrees.

FIG. 13c illustrates an anchor strap extending from an edge of a coupling bag along an anchor loop axis, which can be perpendicular to an edge axis of the edge of the coupling bag.

FIG. 14 illustrates another example configuration of coupling straps where a first coupling strap is coupled to the first end coupling tab and a first peripheral coupling tab, and where a second coupling strap is coupled to a second end coupling tab and a second peripheral coupling tab.

FIG. 15 illustrates an example where coupling straps are used to couple a coupling bag and associated pad body to a recliner where the coupling straps extend around the back of the body of the recliner and crisscross.

FIG. 16 illustrates an example embodiment where the pad body of the alternating pressure pad comprises a first pair of end coupling tabs on a first end of the coupling bag and a second pair of end coupling tabs on a second end of the coupling bag that is opposite the first end.

FIG. 17a illustrates an example where the pad body defines a coupling hole having a hole axis H through which a peripheral coupling strap loops to couple a peripheral coupling tab to the pad body, which disposes the peripheral coupling tab at +60 degrees relative to a linear edge axis E.

FIG. 17b illustrates an example where the pad body defines a coupling hole having a hole axis H through which a peripheral coupling strap loops to couple a peripheral coupling tab to the pad body, which disposes the peripheral coupling tab at −60 degrees relative to a linear edge axis E.

FIG. 17c illustrates an example of an end coupling tab that is coupled to an edge of a pad body at an angle of 90 degrees.

FIG. 18 illustrates an embodiment of an anchor strap comprising an anchor loop, which is coupled to the edge of a pad body with the anchor loop extending through an anchor hole defined by the pad body.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

The present disclosure relates to systems and methods for securing inflatable pads to furniture articles such as beds and recliners, addressing fundamental challenges in both medical and consumer applications. Conventional inflatable pads can become displaced during use, leading to reduced effectiveness and compromised user comfort. This displacement is particularly problematic in medical settings, where pad movement can result in improper pressure distribution, potentially contributing to the development of pressure ulcers in bedridden patients or exacerbating existing conditions.

The described coupling systems and methods in various embodiments can provide a robust solution for maintaining inflatable pad positioning, ensuring consistent therapeutic benefits and enhanced user comfort across extended periods of use. By securely fastening the inflatable pad to the underlying furniture article, the system in various examples can prevent unwanted shifting and bunching that can occur during normal movement, patient repositioning, deployment or retraction of a footrest, or the pad's inflation/deflation cycles. This stability can be desirable in various embodiments of an alternating pressure system where precise pad placement can be desirable for proper pressure distribution and the prevention of pressure-related complications.

Various embodiments discussed herein include a pressure pad system designed to be coupled with various articles, such as beds or recliners with a mattress or one or more cushions. The system in some examples includes a pad body with a rectangular shape, constructed from layers of polyvinyl chloride (PVC) that are welded together to form separate chambers. These chambers can be independently inflated or deflated, allowing for customizable pressure distribution across the pad.

To secure the pressure pad system to an article, various embodiments can include one or more coupling mechanisms, which can include end and peripheral coupling tabs equipped with side-squeeze buckle assemblies, which can be used in conjunction with coupling straps to firmly attach the pad to the article. Additionally, anchor straps can be integrated into the design in some examples, providing further stability by fitting into slots on the frame or body of an article such as a bed, recliner, or the like. This can ensure that the pad remains securely in place, even when the article (e.g., a recliner) transitions between different configurations, as the pad inflates and deflates, as a user on the pad moves around, or the like.

A system and method of various embodiments includes a coupling bag, which houses a pad body. This bag can feature a zipper or closure mechanism that allows for easy insertion and removal of the pad into the bag. The coupling bag in some examples can correspond to a rectangular shape of the pad body and provide for securing the pad body to an article such as a recliner, bed, or the like. Such a pressure pad system in method in some examples can offer a versatile solution for enhancing comfort and support on various seating and resting surfaces.

Inflatable pads can have strong flexibility and elasticity, and after inflation, their expansion volume increases. Inflatable pads can include advantages such as non-deformability, comfortable body feel, and easy portability. Some inflatable pads can be used for family and travel, and in some examples, only have one inflatable chamber and the mattress can be inflated through one inflation port. Such a structure can be designed to be convenient to carry.

Some inflatable pads used in medical care can divide the mattress into two compartments: front and rear. By filling and releasing gas from the compartments, the patient can be raised in the upper part of the body and lowered in the lower part of the body, and vice versa, which can facilitate the patient's sitting posture and can facilitate care. Another type of inflatable pad can include two inflatable chambers on the left and right sides of the pad, which can be filled with gas to achieve left high, right low, or right high, left low for patients to roll over in some examples.

For patients who have been bedridden for a long time, an inflatable pad can leak, and the pad can collapse. For patients with bedsores or prone to bedsores, when an inflatable pad collapses, patients can touch the bed board, causing damage to patient's existing bedsores and/or causing bedsores to form.

For patients with bedsores or prone to bedsores, in various embodiments it can be desirable to provide an alternating pressure pad system that provides varying contact with body of the patient while also providing a stable bed for the patient. Additionally, it can be desirable to provide a pad that provides characteristics such as a high-friction top surface that prevents slipping and sliding of the patient on the top of the pad while also providing a surface that is comfortable to the touch and reduces excess moisture by managing the heat and humidity of the skin of the patient. Additionally, given that bedridden patients may rest on an inflatable pad for long periods of time (e.g., days, weeks, months or years), it can be desirable to provide a pad that is durable and configured for constant use, including constant inflation and deflation and constant pressure of the patient on the pad. An alternating pressure pad as discussed herein can provide relief and comfort to patients by providing alternating pressure on skin surfaces and bony prominences. The slow inflation and deflation in some embodiments can increase circulation and reduce the need of exhausting, yet otherwise necessary, constant turning or moving of the patient to prevent discomfort, bedsores, blood clots, and the like.

Various embodiments disclosed herein provide a flocked multi chamber alternating pressure pad that comprises a first layer and a second layer. In some embodiments, the first layer is a flocked PVC (Polyvinyl Chloride) sheet ranging from 0.50 mm-0.70 mm in thickness that is welded to the second layer, which is a PVC sheet ranging from 0.29-0.40 mm in thickness.

In some embodiments, the multi chamber inflatable pad includes a lining layer arranged at the edge of the first layer, wherein the contour of the lining layer complements the contours of the first and second chambers to provide an overall rectangular pad. For example, such a pad can be generally rectangularity-sized for a single human adult or child user, for a twin bed, for a queen-sized bed, for a king-sized bed, and the like. In some embodiments, the lining layer can comprise, consist essentially of or consist of a flocking layer. Flocking technology in various embodiments can integrate various velvet materials onto one or more layers of PVC material and can be beneficial to the user experience.

Flocking on PVC sheets can include a manufacturing process for achieving a textured or velvety surface finish on a PVC sheet. Flocking can be desirable in various applications where a soft feel, enhanced aesthetic appearance, or improved grip is desired. In an example, a manufacturing process begins with the preparation of a PVC substrate such as a sheet of PVC, which can be cleaned and pre-treated to ensure optimal adhesion of the flocking material. An adhesive (e.g., in liquid form) can be uniformly applied to a face of the PVC sheet. The choice of adhesive in some examples can depend on factors such as the type of flocking material being used and the desired properties of the final flocked product. A flocking material in various examples can be composed of tiny fibers (flock).

In some embodiments, such flocking fibers or flock can include microfibers, with diameters typically between 0.5 and 2 deniers (a “denier” is a unit of measurement used to quantify the thickness of threads and fibers in textiles; it is defined as the mass in grams per 9000 meters of the fiber. In other words, if a 9000-meter length of a specific fiber weighs 1 gram, that fiber is 1 denier).

In some embodiments, such flocking fibers or flock can include microfibers having a length of less than or equal to 0.25 mm, 0.5 mm, 0.75 mm, 1 mm, 1.5 mm, 2.0 mm, 2.5 mm, 3 mm, 4 mm, 5 mm, 6 mm, 7 mm, 8 mm, 9 mm, 10 mm, or the like, or a range between such example values.

In some embodiments, flocking fibers, can be characterized by deniers from 1 to 10 and lengths spanning 0.5 to 5 millimeters. In further embodiments, flocking fibers, can be characterized by being within the 10 to 40 denier range and lengths of 1 to 5 millimeters. In various embodiments, flocking fibers can be cylindrical or other suitable shape.

During manufacturing of a flocked sheet of PVC, the flocking material can be electrostatically charged, which in various examples can provide for the flocking material to adhere vertically to the adhesive-coated PVC surface, creating a directional orientation. The application of the charged flock can allow for control over the flock's alignment and density.

Once the electrostatically charged flocking materials can be applied to the adhesive-coated PVC sheet, the adhesive can be cured or dried, which can permanently affix the flock to the PVC surface. This can generate a durable and long-lasting flocking finish in various embodiments. Depending on the desired outcome, in some examples additional processes may be employed to align the flock in one or more specific directions, creating patterns or textures that enhance both the visual and tactile aspects of the flocked PVC sheet.

Throughout the manufacturing process, in various embodiments quality control measures can be implemented to ensure uniform flock distribution, optimal adhesion strength, and overall product consistency. The flocking process can provide customization options in some examples, including varying flock lengths, color choices, and the creation of intricate patterns, providing flexibility in design.

In various embodiments, resulting flocked or velvety surface not only enhances the aesthetic appeal of the PVC sheet but also adds a tactile dimension, making it suitable for applications where grip, touch, temperature control and humidity control are desirable. In various examples, a flocking manufacturing process can generate a finished product that withstands wear and tear, making it suitable for a wide range of applications including one or more embodiments discussed herein.

While examples of PVC sheets are discussed herein in various examples, in some embodiments any suitable material can be flocked and used to generate various embodiments. For example, such materials can include Thermoplastic Polyurethane (TPU), Ethylene-vinyl Acetate (EVA), Polyethylene (PE), rubber, and the like.

In some embodiments, a multi chamber inflatable pad further includes an extension portion connected to the ends of the first and second layers. The extension part can increase the coverage area of the inflatable pad and facilitate its fixation (e.g., it can be clamped or pressed tightly with the bed body through the extension block). In some embodiments, the extension portion is expandable and has a third inflation port. In some embodiments, the extension portion is a solid component, allowing for direct use. In some embodiments, the contour between the first bifurcation and the adjacent second bifurcation is linear, such as having a stepped cross-sectional contour. In some embodiments, the contour between the first bifurcation and the adjacent second bifurcation is curved, such as having a wavy cross-sectional contour.

Various embodiments of an alternating pressure pad can achieve different air pressures in different chambers by generating multiple chambers in a pad and configuring separate inflation ports in each chamber that can allow for the separate chambers to be selectively inflated and deflated separately to provide alternating pressure in the separate chambers in some examples. For example, different air pressures in the two chambers can cause the height of the upper surface of the two chambers to raise and lower separately, allowing for alternating or changing location of the upper surface of the alternating pressure pad that contacts the body of the user, which in various examples can avoid long-term contact of the alternating pressure pad in the same body area. In various embodiments, this can be desirable for the rehabilitation of patients with bedsores, to prevent bedsores from forming, or to increase patient comfort. As discussed herein, various embodiments include a flocking layer, which can make the alternating pressure pad more comfortable and softer for the patient.

Various embodiments include staggered chambers through separated parts of the alternating pressure pad, each of which chambers can provide support for the patient's body. A first and second chamber can be separate such that if one chamber leaks, the other chamber will not collapse or leak, and the support for the patient can remain effective, avoiding contact between the patient's bedsore position and a bed board or other surface that the alternating pressure pad is disposed on.

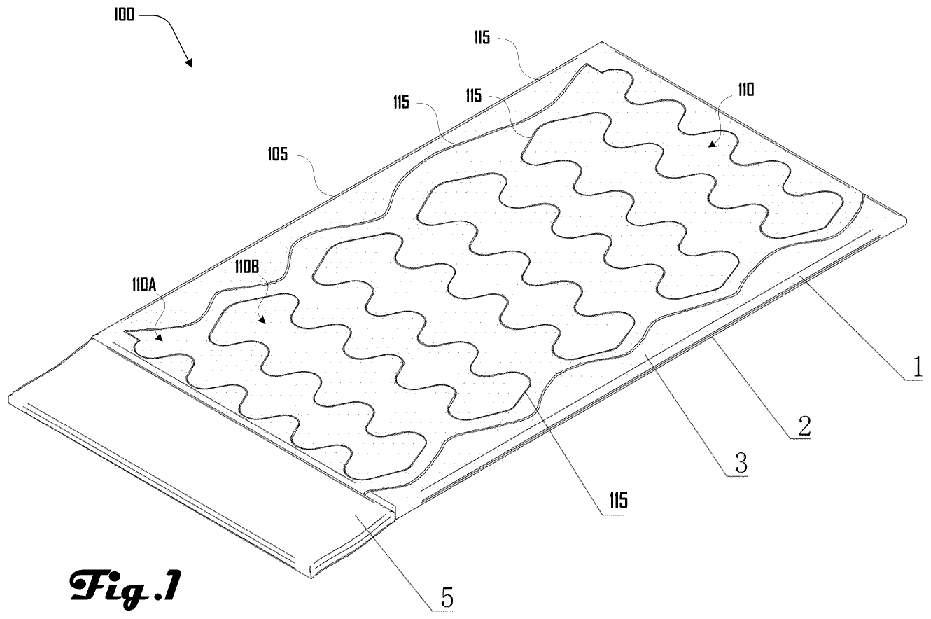

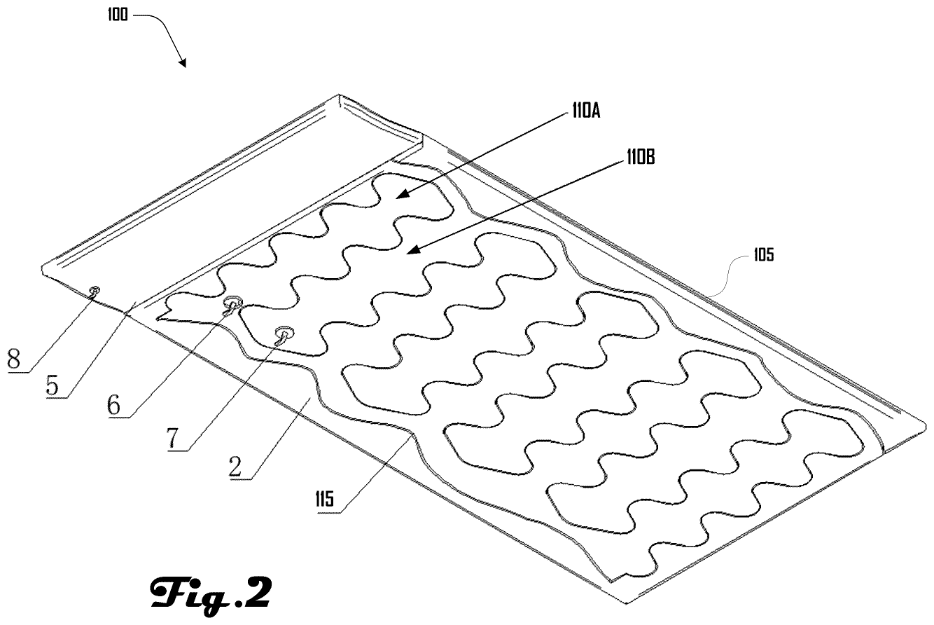

Turning to FIGS. 1-5, example embodiments of an alternating pressure pad 100 are illustrated. In this example, the alternating pressure pad 100 comprises a pad body 105 that defines a first and second inflatable chamber 110A, 110B. The pad body 105 can comprise a first layer 1 and a second layer 2 that are defined by respective sheets of material (e.g., sheets of PVC material). Edge and/or central portions of the first layer 1 and the second layer 2 can be sealed/coupled together (e.g., by welding as discussed herein) to define the first and second layers 1, 2. A lining layer 3 can be disposed on an outer side of one or both of the first layer 1 and the second layer 2. In various embodiments, the lining layer 3 can comprise, consist essentially of or consist of a flocking layer. In some embodiments, a flocking layer can be manufactured in various suitable ways and have various suitable characteristics, including the examples discussed herein.

In some embodiments, the first layer 1 comprises, consists essentially of or consists of a flocked planar sheet ranging from 0.5 mm-0.7 mm in thickness. In one preferred embodiment, the thickness of the flocking portion is 0.2 mm and the thickness of the sheet portion (e.g., PVC sheet) is 0.4 mm.

In some embodiments, a flocked planar sheet can have a thickness of 0.2 mm, 0.25 mm, 0.3 mm, 0.35 mm, 0.4 mm, 0.45 mm, 0.5 mm, 0.55 mm, 0.6 mm, 0.65 mm, 0.7 mm, 0.75 mm, 0.8 mm, 0.85 mm, 0.9 mm, 0.95 mm, 1.0 mm, or the like, or a range between such example values.

In some embodiments, a flocked portion of the first layer 1 can have a thickness of 0.1 mm, 0.12 mm, 0.14 mm, 0.16 mm, 0.18 mm, 0.2 mm, 0.22 mm, 0.24 mm, 0.26 mm, 0.28 mm, 0.3 mm, or the like, or a range between such example values. In various examples, the thickness of the flocked portion can be defined by the thickness of flocking material coupled to a sheet portion of the first layer 1 while the flocking material is generally lying flat against the face of the sheet portion of the first layer 1.

In some embodiments, a sheet portion of the first layer 1 can have a thickness of 0.05 mm, 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.65 mm, 0.7 mm, 0.75 mm, 0.8 mm, 0.85 mm, 0.9 mm, 0.95 mm, 1.0 mm, or the like, or a range between such example values. In some embodiments, the sheet portion of the first layer 1 comprises, consists essentially of or consists of PVC. In one preferred embodiment, the thickness of the first layer 1 can be a total of 0.6 mm with 0.2 mm of a sheet portion (e.g., PVC) and 0.4 mm of a flocking portion.

It should be clear that in various embodiments the novel thicknesses or ranges of thicknesses of the first layer 1, the flocked portion of the first layer 1 and the sheet portion of the first layer 1 are specifically selected to provide an optimum durability, comfort and weight of the alternating pressure pad 100 and are not simply an obvious design choice or optimization. For example, the novel thicknesses or ranges of thicknesses of the first layer 1, the flocked portion of the first layer 1 and the sheet portion of the first layer 1 can be specifically selected to have at least a minimum thickness to provide suitable durability for use as an alternating pressure pad 100 for a bedridden human adult patient that will be lying on the alternating pressure pad 100 for an extended period of time such as days, weeks, months or years. However, the novel thicknesses or ranges of thicknesses of the first layer 1, the flocked portion of the first layer 1 and the sheet portion of the first layer 1 can be specifically selected to have a thickness that is no greater than necessary so as to minimize weight of the alternating pressure pad 100, provide suitable flexibility of the alternating pressure pad 100, and to provide for suitable manufacturing as discussed herein.

For example, in one embodiment, using a flocked or non-flocked PVC sheet that is greater than or equal to 0.60 mm for one or both sides of the alternating pressure pad 100 would be cost-prohibitive due to the weight of the product (e.g., shipping costs increase as do the costs of the material). Accordingly, arguing that novel thicknesses or ranges of thicknesses discussed herein are obvious design choices or obvious optimizations would be impermissibly relying on hindsight reasoning in view of the present disclosure.

In one preferred embodiment, the first and/or second layers 1, 2 can have a puncture resistance of less than 39 lbf and greater than 18.5 lbf. In some examples, such a range can provide a desirable balance between durability and weight for the application of providing a flocked alternating pressure pad for bedsore prevention.

In some embodiments, the first and/or second layers 1, 2 can have a puncture resistance of less than 26 lbf, 27 lbf, 28 lbf, 29 lbf, 30 lbf, 31 lbf, 32 lbf, 33 lbf, 34 lbf, 35 lbf, 36 lbf, 37 lbf, 38 lbf, 39 lbf, 40 lbf, 41 lbf, 42 lbf, or the like or a range between such example values.

In some embodiments, the first and/or second layers 1, 2 can have a puncture resistance of greater than 16 lbf, 17 lbf, 18 lbf, 19 lbf, 20 lbf, 21 lbf, 22 lbf, 23 lbf, 24 lbf, 25 lbf, 26 lbf, 27 lbf, 28 lbf, 29 lbf, or the like or a range between such example values.

In one preferred embodiment, a flocked first layer 1 can have a puncture resistance of between 29 lbf and 32 lbf and a non-flocked second layer 2 can have a puncture resistance of between 24 lbf and 26 lbf.

In some embodiments, a flocked first layer 1 can have a puncture resistance of 25 lbf, 26 lbf, 27 lbf, 28 lbf, 29 lbf, 30 lbf, 31 lbf, 32 lbf, 33 lbf, 34 lbf, 35 lbf, 36 lbf, 37 lbf, or the like or a range between such example values.

In some embodiments, a non-flocked second layer 2 can have a puncture resistance of 19 lbf, 20 lbf, 21 lbf, 22 lbf, 23 lbf, 24 lbf, 25 lbf, 26 lbf, 27 lbf, 28 lbf, 29 lbf, 30 lbf, 31 lbf, or the like or a range between such example values.

In some embodiments, the second layer 2 comprises, consists essentially of or consists of a planar sheet ranging from 0.29-0.40 mm in thickness. In one preferred embodiment, the second layer 2 has a thickness of 0.35 mm. In some embodiments, a sheet portion of the first layer 2 can have a thickness of 0.05 mm, 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.65 mm, 0.7 mm, 0.75 mm, 0.8 mm, 0.85 mm, 0.9 mm, 0.95 mm, 1.0 mm, or the like, or a range between such example values. In some embodiments, the second layer 2 comprises, consists essentially of or consists of PVC.

The alternating pressure pad 100 can define two independent and staggered chambers 110 based at least on one or more couplings 115 between the first layer 1 and the second layer 2. Each chamber 110 can be equipped with a separate inflation port, which can provide for different air pressures/volumes to be generated in the different chambers 110 and allowing for alternating pressure in the respective chambers 110. For example, a generated difference in air pressure between the two chambers 110 can result in differences in the height of the top surfaces of the two chambers 110 opposing bottom surfaces that engage a bed or other surface that the alternating pressure pad 100 is disposed on. By alternating the height of the chambers 110 the portions of the alternating pressure pad 100 that contact the patient can be varied or the pressure on different portions of the patient's body can be varied based on the changing height of the chambers 110. Such configurations can include first chamber 110A being high and second chamber 110B being low; first chamber 110A being low and second chamber 110B being high; both first and second chambers 110 being low; and both first and second chambers 110 being high. Varied pressure and contact on the body of the patient through inflation and/or deflation of the chambers 110 can be desirable for preventing bedsores and expediting healing of existing bedsores where present. In various embodiments, the lining layer 3 (e.g., flocking layer) can make the alternating pressure pad 100 more comfortable and softer for the user, prevent slipping on the alternating pressure pad 100, provide for heat and/or moisture control, and the like.

In some embodiments, the alternating pressure pad 100 includes a first layer 1 and a second layer 2, wherein the second layer 2 is connected to the first layer 1 at the outer edge. In some embodiments, the one or more couplings 115 between the first and second layers can be a direct coupling between the first and second layers 1, 2 (e.g., via welding, an adhesive or the like).

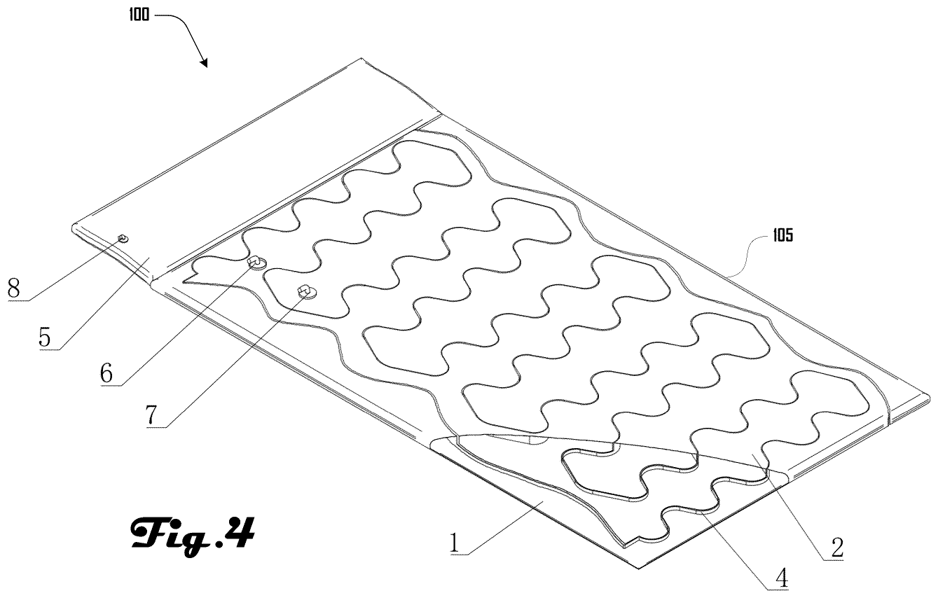

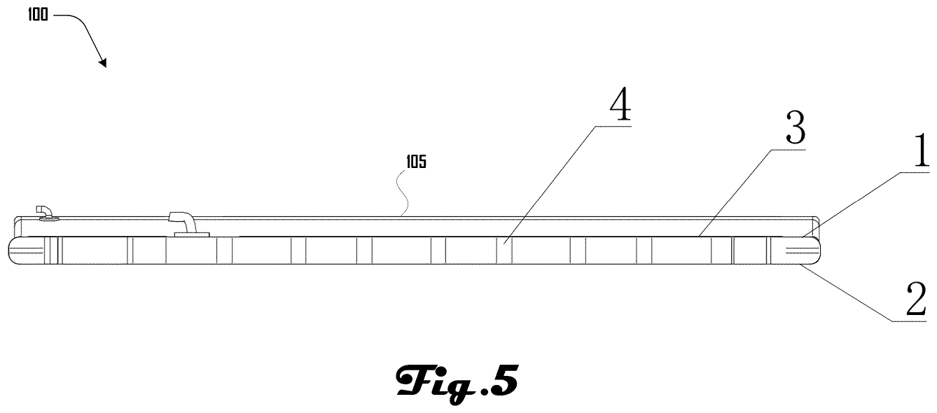

However, in some embodiments, the first and second layers 1, 2 can be separated by a partition 4 (see e.g., FIGS. 4 and 5) that couples the first and second layers 1, 2 and defines the first chamber 110A and the second chamber 110B. For example, in various embodiments such a partition 4 can be a planar sheet comprising the same material(s) as one or both of the first and second layers 1, 2 with the partition 4 being coupled to the first and second layers 1, 2 in various suitable ways such as via welding, an adhesive, or the like.

In various embodiments, the first chamber 110A can be inflated and/or deflated via a first air charging port 6, that can be coupled to the first or second layer 1, 2 to define a passage through which air (or other suitable fluid) can be introduced into the first chamber 110A. In various embodiments, the second chamber 110B can be inflated and/or deflated via a second air charging port 7, that can be coupled to the first or second layer 1, 2 to define a passage through which air (or other suitable fluid) can be introduced into the second chamber 110B.

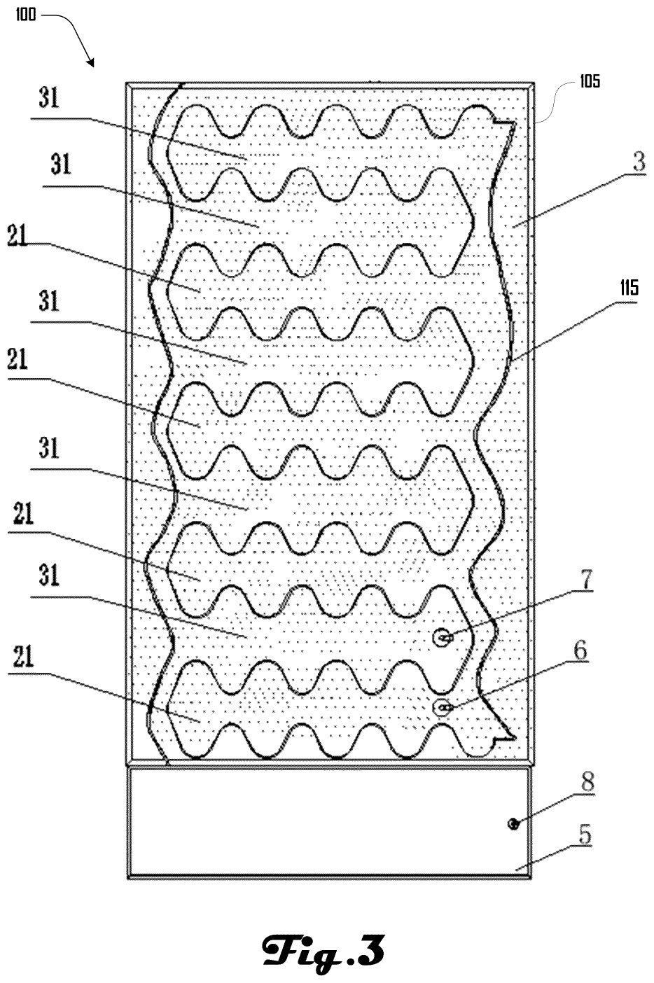

In various embodiments, the first and second chambers 110A, 110B can respectively define a plurality of first forks 21 and second forks 31 (see e.g., FIG. 3). Such first and second forks 21, 31 can be staggered and have a central axis that is parallel to a width axis of the alternating pressure pad 100 and perpendicular to a length axis of the alternating pressure pad 100.

Such a staggered chamber configuration can be desirable to provide support along the length of the body of a patient lying on the alternating pressure pad 100 (e.g., with the transverse axis of the patient generally along the length axis of the alternating pressure pad 100), even if one of the first and second chambers 110A, 110B is deflated due to alternating inflation or structural failure of a chamber 110.

In various embodiments, the alternating pressure pad 100 can comprise an extension member 5, which in some examples increases the overall length of the alternating pressure pad 100. The extension member 5 in some examples can be configured to increase the coverage area of the alternating pressure pad 100, provide for a head or footrest for a user, facilitate fixation of the alternating pressure pad 100 (e.g., to a bed, mattress or other surface or object that the alternating pressure pad 100 is disposed on).

In various embodiments, the extension member 5 can comprise an inflation port 8 that can be used to inflate and/or deflate the extension member. Accordingly, in some embodiments the extension member 5 cavity that can be filled with air or other suitable fluid. In some embodiments, the extension member 5 can be a solid component without such an inflatable cavity. In various embodiments, the extension member 5 can be defined by one or more planar sheets (e.g., PVC, flocked PVC, or the like).

The thickness of the extension member 5 in one preferred embodiment can be 0.18 mm. In some embodiments, the extension member 5 can have a thickness of 0.05 mm, 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.65 mm, 0.7 mm, 0.75 mm, 0.8 mm, 0.85 mm, 0.9 mm, 0.95 mm, 1.0 mm, or the like, or a range between such example values. In some embodiments, extension member 5 comprises, consists essentially of or consists of PVC.

Also, while various examples herein illustrate a single extension member 5 extending from one end of the length of the alternating pressure pad 100, further embodiments can include any suitable plurality of extension members 5 including extension members 5 extending from opposing sides of the length of the alternating pressure pad 100, one or more extension members 5 extending from one or both sides of the width edges of the alternating pressure pad 100, or the like.

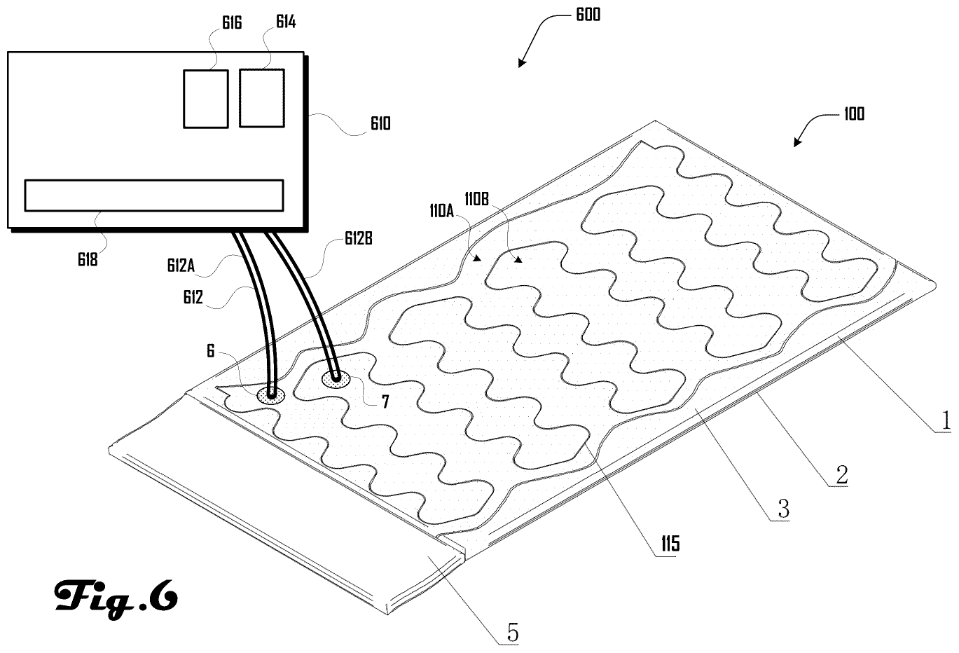

Turning to FIG. 6, an example of an alternating pressure pad system 600 is illustrated that comprises an alternating pressure pad 100 and a pump system 610. As shown in this example embodiment, the pump system comprises a first tube 612A and second tube 612B that are respectively coupled with a first port 6 and second port 7. In various embodiments, the pump system 610 can be configured to separately inflate and/or deflate first and second chambers 110A, 110B of the alternating pressure pad 100 by introducing and/or removing air (or other suitable fluid) from the first and second chambers 110A, 110B via the first and second tubes 612A, 612B and first and second ports 6, 7 that communicate with the first and second chambers 110A, 110B.

In various embodiments, the pump system 610 can be a suitable electronic or computing device, which can include elements like a processor, memory and the like. The pump system 610 can comprise a computer readable medium (e.g., memory) that stores instructions that when executed cause the pump system 610 to perform various functions including an automated alternating pressure routine that can include alternatingly inflating and deflating the first and second chambers 110A, 110B as discussed herein. Such a routine can alternatingly inflate and deflate the first and second chambers 110A, 110B in a looping cycle in various examples.

In some embodiments, the pump system 610 can comprise an interface that comprises a power switch 614, a routine selection switch 616, and a pressure slider 618. In various examples, the power switch 614 can power or de-power the pump system 610, with power supplied to the pump system 610 in various suitable ways including via plugging into a wall receptacle, a battery, or the like. In various examples, the routine selection switch 616 can allow for selection between a static inflation state or an automated alternating pressure routine as discussed herein. In various examples, the pressure slider 618 can allow a user to select a firmness setting of the alternating pressure pad 100, which can include a firmness for a static pressure mode, a maximum pressure for the chambers 110 during an alternating pressure routine, or the like. Additionally, in various embodiments, the pump system 610 can comprise other suitable components such as one or more pumps, one or more valves, a touchscreen, a wired or wireless communication device (e.g., that allows communication with a local device such as a smartphone or remote devices via the Internet, or the like). In some embodiments, the pump system 610 can be configured to inflate and/or deflate one or more extension members 5.

An alternating pressure pad 100 can be manufactured in various suitable ways. For example, sheets for first and second layers 1, 2 can be provided (e.g., flocked and/or non-flocked planar PVC sheets) and the first and second layers 1, 2 can be coupled together in various suitable ways with one preferred embodiment including high-frequency welding. Further embodiments can include any suitable welding or coupling method including heat sealing, radio frequency (RF) welding, ultrasonic welding, solvent bonding, hot gas welding, an adhesive, a tape, mechanical fastening, and the like.

In one preferred embodiment, a hydraulic press uses 30 kg of pressure to press the first and second layers 1, 2 together while a 9-amp current melts and couples the first and second layers 1, 2 in about 2.3 seconds. In some embodiments, a welding current can be between 6-13 amps; hydraulic pressure can be between 20-40 kg; and welding time can be between 1-5 seconds. In various embodiments, a flocked portion of a layer 1,2 can have a thickness of 0.01 mm-1.0 mm; a sheet portion of a layer 1, 2 can have a thickness of 0.01 mm-1.0 mm (e.g., a PVC sheet); and a total thickness of a layer 1, 2 can be between 0.01-2.0 mm.

The novel thicknesses or ranges of thicknesses of the first layer 1, the flocked portion of the first layer 1 and the sheet portion of the first layer 1 can be specifically selected to have a thickness that is no greater than necessary so as to minimize weight of the alternating pressure pad 100, provide suitable flexibility of the alternating pressure pad 100, and to provide for desired manufacturing within parameters discussed herein. Accordingly, arguing that such novel thicknesses or ranges of thicknesses are obvious design choices or obvious optimizations would be impermissibly relying on hindsight reasoning in view of the present disclosure.

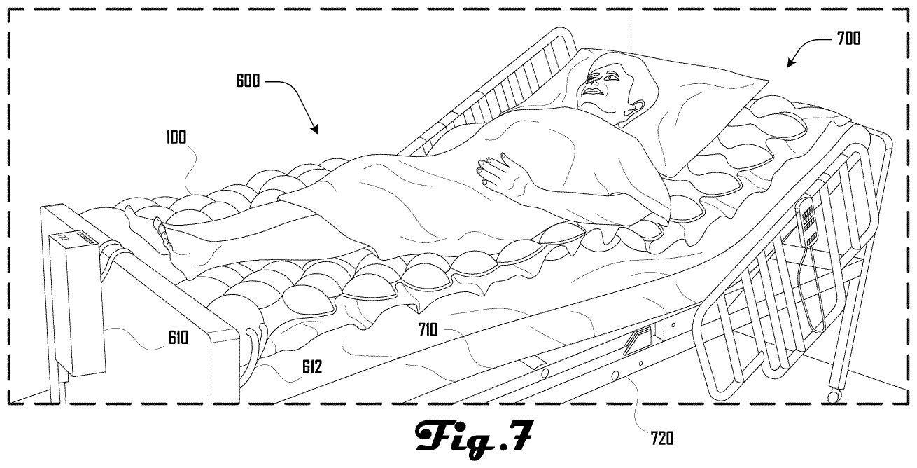

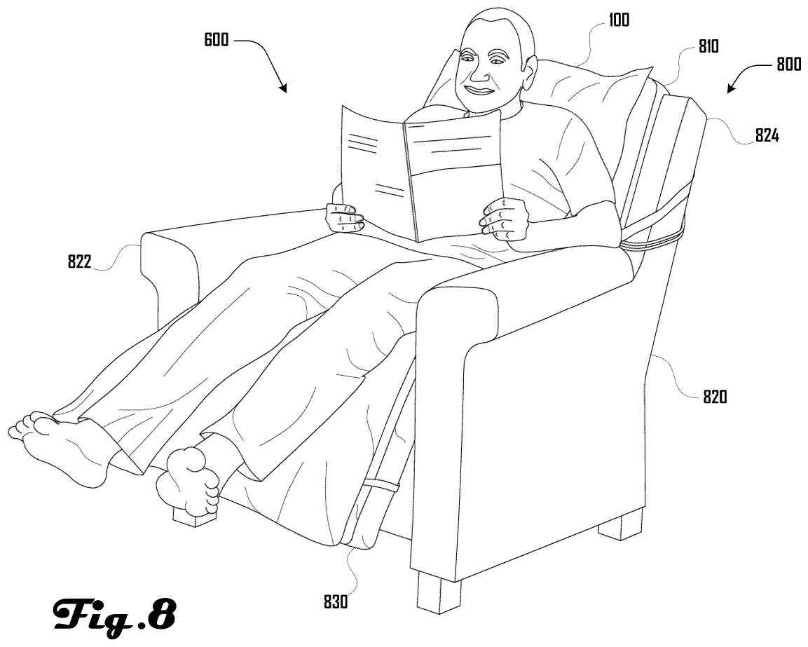

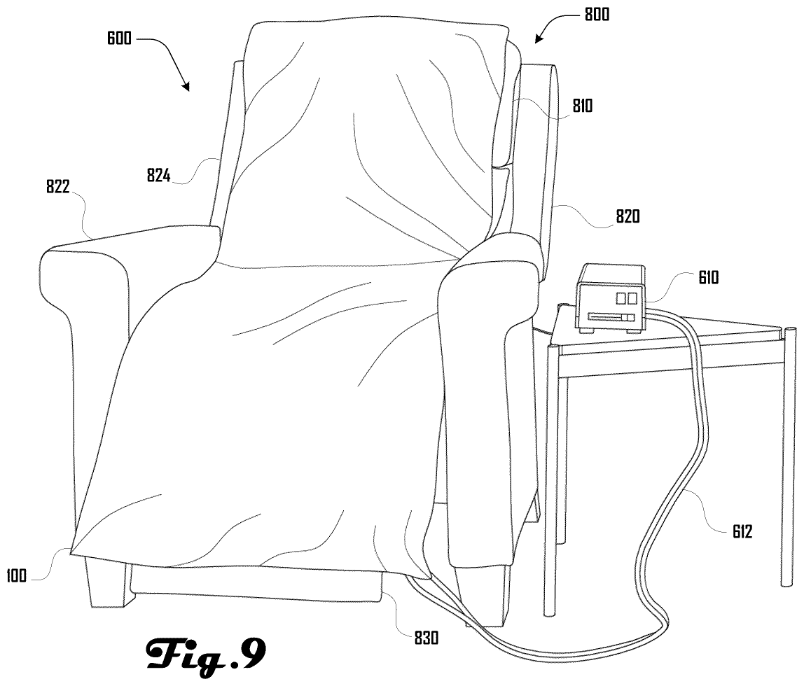

In various embodiments, an alternating pressure pad 100 and pressure pad system 600 can be used in various scenarios such as on a bed 700 as shown in FIG. 7 or in a recliner 800 as shown in FIG. 8. For example, FIG. 7 illustrates a user lying on an alternating pressure pad 100 on a bed 700 that includes a mattress 710 and a bed frame 720. In another example, FIG. 8 illustrates a user sitting on an alternating pressure pad 100 in a recliner 800 that includes one or more cushions 810; a recliner body 820 that includes arms 822 and a back 824; and footrest 830. In a further example, FIG. 9 illustrates a pressure pad system 600 disposed on a recliner 800 that includes one or more cushions 810; a recliner body 820 that includes arms 822 and a back 824; and footrest 830. While the examples of a bed 700 and recliner 800 are used herein, it should be clear that an alternating pressure pad 100 and/or pressure pad system 600 can be used in various ways in accordance with further embodiments, including in a chair, couch, lounger, car seat, office chair, dining chair, bench, window seat, stadium bleacher, patio furniture, garden kneeler, camping chair, floor cushion, picnic blanket, boat seat, wheelchair, church pew, theater seat, pool lounger, deck chair, hammock, folding chair, and the like.

In various embodiments, it can be desirable to couple the alternating pressure pad 100 to a bed 700, recliner 800, or the like. For example, it can be desirable to couple the alternating pressure pad 100 such that it remains substantially in the same location, does not move around or shift and remains coupled in location, which can be beneficial in some embodiments to improve user experience and comfort. The alternating pressure pad 100 can be specially configured to couple with a specific type of furniture or can be configured to couple with multiple types of furniture in some embodiments.

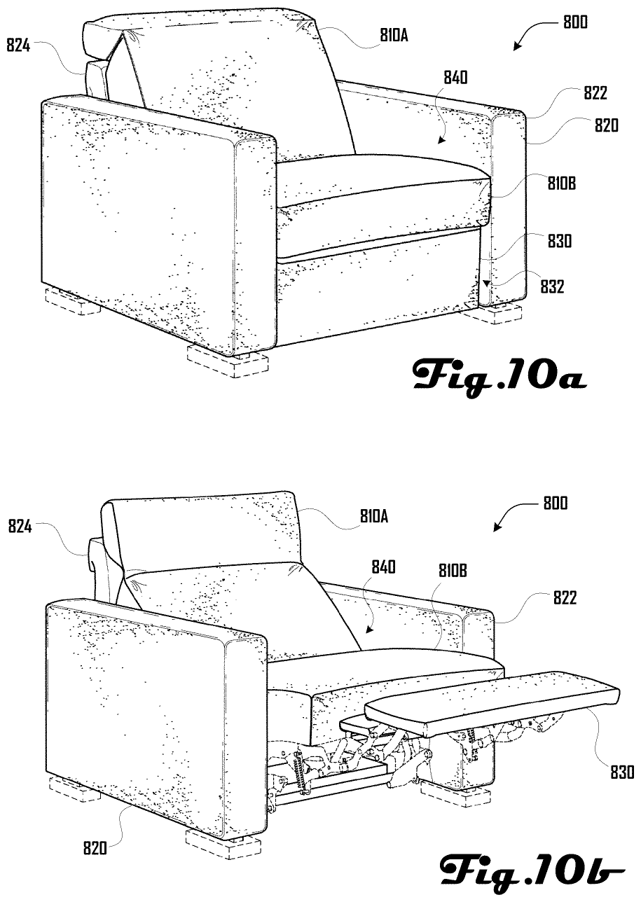

For example, FIGS. 10a and 10b illustrate an example embodiment of a recliner 800 that includes first and second cushions 810A, 810B; a recliner body 820 that includes arms 822 and a back 824; footrest 830 that is configured to extend (FIG. 10b) and retract (FIG. 10a); and slots 840 between the cushions 810A, 810B and arms 822. As discussed in more detail herein, alternating pressure pad 100 of various embodiments can include suitable elements, structures, shape, or the like, that allows for the alternating pressure pad 100 to be coupled to such a recliner 800.

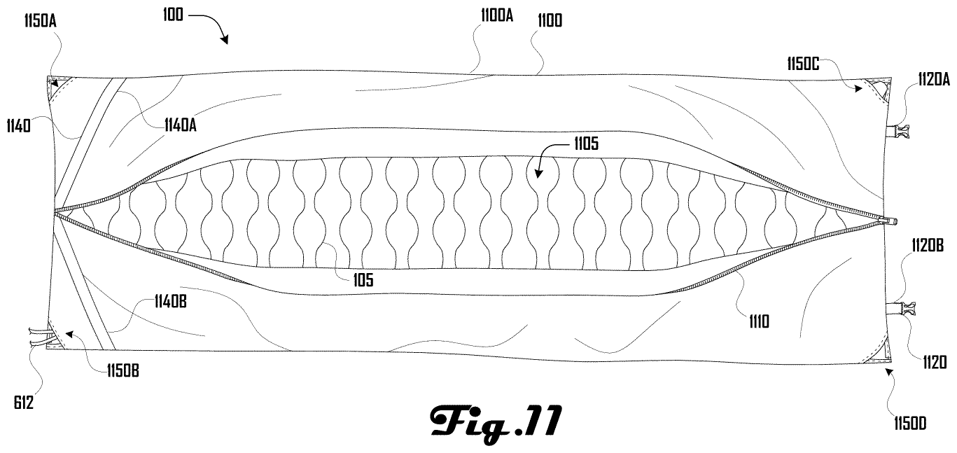

For example, FIG. 11 illustrates an example embodiment 1100A of a coupling bag 1100 that defines a bag cavity 1105 in which the pad body 105 of the alternating pressure pad 100 can be disposed. In some embodiments, the coupling bag 1100 can comprise a front and rear rectangular sheet (of fabric, polymer, or the like) with a bag zipper 1110 disposed along a central length axis extending from a first end to a second end. Opening the zipper 1110 can allow the pad body 105 to be inserted into and/or removed from the bag cavity 1105 and closing the zipper 1110 can allow the pad body 105 to be enclosed within the bag cavity 1105.

The coupling bag 1100 in this example 1100A can comprise a pair of end coupling tabs 1120A, 1120B on one end of the coupling bag 1100, which as discussed in more detail herein, can include a socket portion of a side-squeeze buckle assembly in some embodiments. Additionally, the coupling bag 1100 of FIG. 11 comprises four bag ports 1150A, 1150B, 1150C, 1150D defined by the coupling bag 1100 at the four corners of the bag. For example, the bag ports 1150 can be defined in various suitable ways, including a slot, gap, or the like that spans diagonally between an end of the coupling bag 1100 to a side of the coupling bag 1100.

In various embodiments, the bag ports 1150 can be configured for tubes 612 of the pump system 610 to extend through the coupling bag 1100 to the pump system 610 such that air can inflate and deflate the alternating pressure pad 100 within the coupling bag 1100. In various embodiments it can be desirable to have bag ports 1150 on all four corners of the coupling bag 1100 so that the alternating pressure pad 100 can be inserted into the coupling bag 1100 in any orientation and the tubes 612 can still extend through a nearby bag port 1150 (e.g., where pad ports 6, 7 are disposed proximate to a corner of the alternating pressure pad 100 as shown and described in some embodiments herein). Additionally, in some embodiments, the bag ports 1150 can be configured to allow the coupling bag 1100 to breathe, such as to accept and expel air from the bag cavity 1105 as the alternating pressure pad 100 is inflated and deflated as discussed herein.

In some preferred embodiments, some or all of the bag ports 1150 can have a width of 3.5 inches, which can be a desirable size for allowing the tubes 612 of the pressure pad system 600 to extend through the coupling bag 1100 and be snugly held within one of the bag ports 1150, so the size of the bag ports 1150 is not a simple design choice in various embodiments and is instead specifically designed for the tubes 612. In further embodiments, the bag ports 1150 can be various suitable sizes, including having a width of 1.5, 1.75, 2.0, 2.25, 2.5, 2.75, 3.0, 3.25, 3.5, 3.75, 4.0, 4.25, 4.5, 4.75, 5.0, 5.25, 5.5, 5.75, 6.0 inches, and the like or a range between such example values.

In various embodiments, the bag ports 1150 can be defined by the corners of two rectangular planar sheets coupled together with a triangular corner of one of the sheets absent (e.g., a bottom sheet) to define a bag port 1150 between the rectangular planar sheets. Having the triangular corner of a bottom sheet absent can be desirable because such a configuration can maintain the rectangular profile of the coupling bag 1100 from the top, while allowing for one or more bag ports 1150.

Additionally, such an example of defining a bag port 1150 should not be construed as being limiting on the wide variety of shapes, configurations, sizes and number of bag ports 1150 present in further embodiments. For example, in further embodiments, one or more bag ports 1150 can be defined by a slot, grommet, flap, slit, hatch, or the like. Additionally, in some embodiments there can be any suitable number of bag ports 1150 in any suitable location including 1, 2, 3, 4, 5, 6, 7, 8, 9, 10, 12, or the like, or a range between such example values.

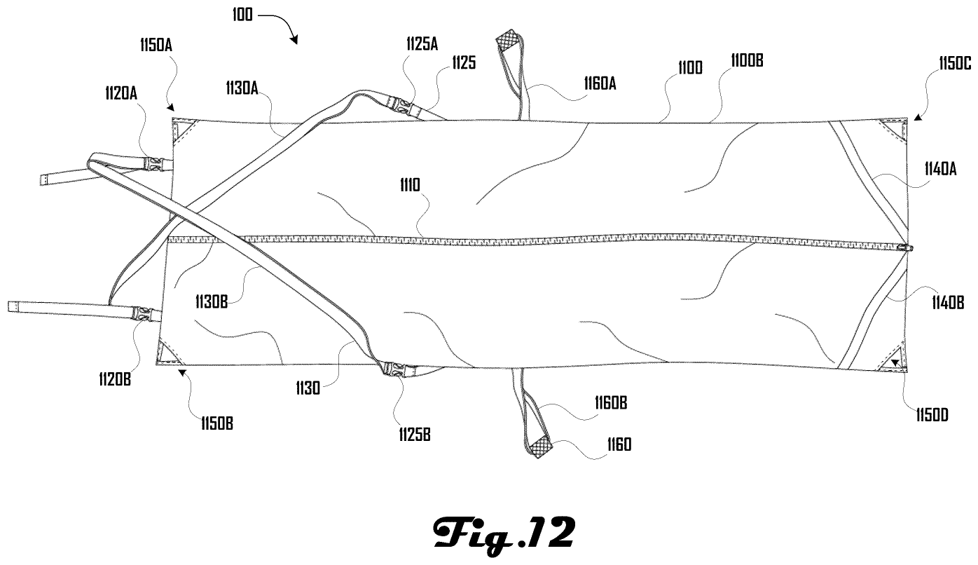

Turning to FIG. 12, another embodiment 1100B of a coupling bag 1100 is illustrated that comprises a bag zipper 1110 disposed along a central length axis extending from a first end to a second end. Opening the zipper 1110 can allow the pad body 105 to be inserted into and/or removed from the bag cavity 1105 and closing the zipper 1110 can allow the pad body 105 to be enclosed within the bag cavity 1105 (see e.g., FIG. 11). The coupling bag 1100 in this example 1100B comprises a pair of end coupling tabs 1120A, 1120B on one end of the coupling bag 1100, which as discussed in more detail herein, can include a socket portion of a side-squeeze buckle assembly in some embodiments. The coupling bag 1100 of FIG. 12 comprises four bag ports 1150A, 1150B, 1150C, 1150D defined by the coupling bag 1100 at the four corners of the coupling bag 1100.

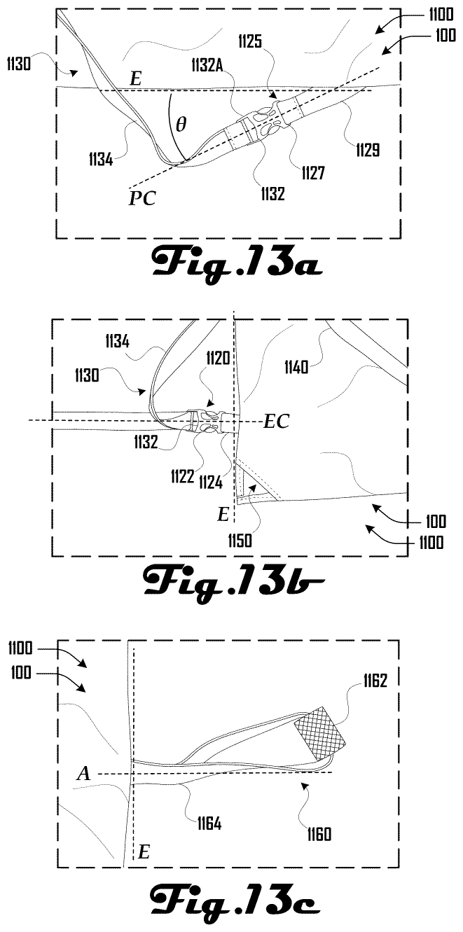

The coupling bag 1100 of FIG. 12 further comprises first and second peripheral coupling tabs 1125A, 1125B and first and second end coupling straps 1130A, 1130B that respectively couple the first and second peripheral coupling tabs 1125A, 1125B to the first and second end tabs 1120A, 1120B. For example, as shown in FIGS. 12, 13a and 13b, in some embodiments, both ends of the coupling straps 1130 can include plug portions 1132 of a side-squeeze buckle assembly that respectively couple with respective socket portions 1122, 1127 of a peripheral coupling strap 1125 and an end coupling strap 1130.

In various embodiments, the end coupling tabs 1120 and peripheral coupling tabs 1125 can be oriented in various suitable ways. For example, FIG. 13a illustrates an example of a peripheral coupling tab 1125 that is coupled to an edge of the coupling bag 1100 at an angle of 25 degrees. Specifically, the coupling bag 1100 has a linear edge axis E and the peripheral coupling tab 1125 defines a peripheral coupling axis PC that can be defined by the peripheral coupling strap 1129 and/or socket 1127. In this example embodiment, the angle θ between the linear edge axis E and peripheral coupling axis PC is 25 degrees; however, in further embodiments, the angle θ between the linear edge axis E and peripheral coupling axis PC can be +/−5, 10, 15, 20, 25, 30, 35, 40, 45, 50, 55, 60, 65, 70, 75, 80, 85 or 90 degrees, or the like, or a range between such example values.

In some embodiments, an angle θ between the linear edge axis E and peripheral coupling axis PC can be 25 degrees or between 20-30 degrees or between 15-35 degrees toward the end of the coupling bag 1100 with end coupling tabs 1120, which can be desirable for coupling the coupling bag 1100 and associated pad body 105 to articles such as a bed 700, recliner 800, or the like, as discussed in more detail herein.

Turning to FIG. 13b, an example of an end coupling tab 1120 is illustrated that is coupled to an edge of the coupling bag 1100 at an angle of 90 degrees. Specifically, the coupling bag 1100 has a linear edge axis E and the end coupling tab 1120 defines an end coupling axis EC that can be defined by the end coupling strap 1124 and/or plug 1122. In this example embodiment, the angle between the linear edge axis E and end coupling axis EC is 90 degrees; however, in further embodiments, the angle between the linear edge axis E and end coupling axis EC can be +/−5, 10, 15, 20, 25, 30, 35, 40, 45, 50, 55, 60, 65, 70, 75, 80, 85 or 90 degrees, or the like, or a range between such example values.

In some embodiments, an angle between the linear edge axis E and end coupling axis EC can be 90 degrees or between +/−85 degrees or between +/−80 degrees, which can be desirable for coupling the coupling bag 1100 and associated pad body 105 to articles such as a bed 700, recliner 800, or the like, as discussed in more detail herein.

In various embodiments, it can be desirable for the ends of the coupling straps 1130 to have the same type of coupler (e.g., plug portions 1132 of a side-squeeze buckle assembly) and for the end and peripheral coupling tabs 1120, 1125 to have the same complementary type of coupler (e.g., socket portions 1122, 1127 of a side-squeeze buckle assembly) so that one or more coupling straps 1130 can be coupled to the end and peripheral coupling tabs 1120, 1125 in a plurality of suitable configurations.

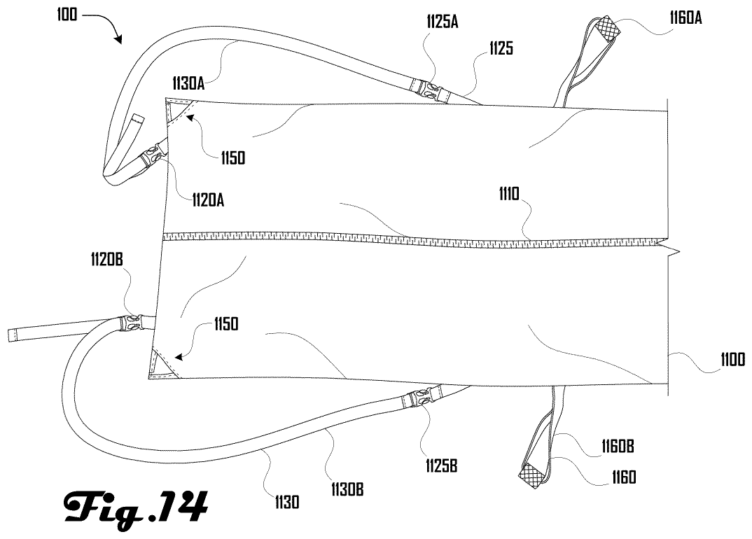

For example, FIG. 12 illustrates a first coupling strap 1130A coupled to the second end coupling tab 1120B and the first peripheral coupling tab 1125A, and illustrates a second coupling strap 1130B coupled to the first end coupling tab 1120A and the second peripheral coupling tab 1125B. However, FIG. 14 illustrates another example configuration where the first coupling strap 1130A is coupled to the first end coupling tab 1120A and the first peripheral coupling tab 1125A, and illustrates the second coupling strap 1130B coupled to the second end coupling tab 1120B and the second peripheral coupling tab 1125B.

However, in some embodiments, one or more coupling straps 1130 can be coupled in various suitable ways, including one example where a coupling strap 1130 is coupled to the first end coupling tab 1120A and the second end coupling tab 1120B, and another example where a coupling strap 1130B is coupled to the first peripheral coupling tab 1125A and the second peripheral coupling tab 1125B.

Additionally, while some embodiments include end and peripheral coupling tabs 1120, 1125 with socket portions 1122, 1127 of a side-squeeze buckle assembly and coupling straps 1130 with plug portions 1132 of a side-squeeze buckle assembly, it should be clear that in some embodiments this arrangement can be opposite with end and peripheral coupling tabs 1120, 1125 having plug portions 1132 of a side-squeeze buckle assembly and coupling straps 1130 having socket portions 1122, 1127 of a side-squeeze buckle assembly.

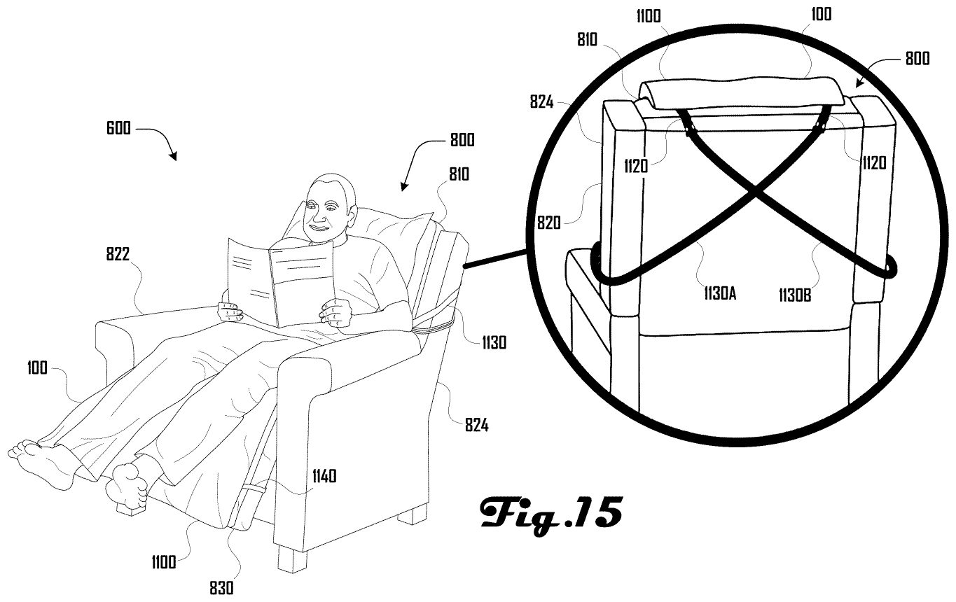

In various embodiments the coupling straps 1130 can be used to couple the coupling bag 1100 to a recliner, bed, chair, or the like. For example, FIG. 15 illustrates an example, where coupling straps 1130 are used to couple a coupling bag 1100 and associated pad body 105 to a recliner 800 where the coupling straps 1130 extend around the back 824 of the body 820 of the recliner 800 and crisscross (see also e.g., FIG. 12). Such a configuration can be desirable in various embodiments to securely couple the coupling bag 1100 and associated pad body 105 to a recliner 800.

In various embodiments, one or more coupling straps 1130 can comprise flexible but inextensible webbing straps 1134 (see e.g., FIGS. 13a and 13b) with the length of the coupling straps 1130 in some examples configured to be adjusted via one or both of the plug portions 1132 (see e.g., FIGS. 12 and 13b). In further embodiments, the length of the coupling straps 1130 can be fixed or the straps 1134 of the coupling straps 1130 can be elastic. Such embodiments can be desirable in some examples so that the coupling straps 1130 can be tightened snugly against the recliner 800 so that the coupling bag 1100 and associated pad body 105 can be securely coupled to the recliner 800 so that the coupling bag 1100 and associated pad body 105 do not substantially shift or move when coupled to the recliner 800.

This example coupling method should not be construed as being limiting and various other suitable coupling methods can be used. For example, the coupling modularity of the coupling straps 1130 in various embodiments can allow the coupling bag 1100 and associated pad body 105 to be coupled to a recliner 800 in various suitable ways; to be coupled to recliners 800 of various sizes, shapes and configurations; or to be coupled to various different articles such as bed 700, or the like.

Also, while a side-squeeze buckle assembly is used in various examples, it should be clear that various other suitable elements can be used for coupling, such as hook and loop fasteners (e.g., Velcro), metal or plastic D-rings with a strap that loops through and back on itself, magnetic clasps or snaps, ladder locks that allow the strap to thread through and adjust, military-style tri-glide slides, metal or plastic cam buckles, double D-ring assemblies where the strap weaves through both rings for security, toggle and loop closures made of wood or plastic, metal spring gate hooks that clip directly onto D-rings or webbing, paracord knots like the bowline or sheet bend, button studs that pop through reinforced holes, metal or plastic G-hooks that catch on webbing loops, metal or plastic oval sliding buckles, metal roller buckles, quick-connect swivel hooks, metal or plastic carabiners, and metal buckles with prongs and holes, and the like.

Returning to the example of FIG. 12, the coupling bag 1100 can comprise a first and second coupling loop 1140A, 1140B, which can extend from a peripheral edge of the coupling bag 1100 to an end of the coupling bag 1100. In various embodiments, the coupling loops 1140 can be fixedly coupled to the edges of the coupling bag 1100 at an opposite end from the one or more end coupling tabs 1120 and can be made of elastic straps, which can allow the coupling loops 1140 to snugly couple to various articles. However, in some examples, the coupling loops 1140 can have an adjustable length and may or may not be inextensible.

In various embodiments, such as shown in FIG. 15 (see also FIG. 8), the coupling loops 1140 can be configured to couple about ends and sides of a footrest 830 of a recliner 800 to couple the coupling bag 1100 and associated pad body 105 to the recliner 800. For example, the coupling loops 1140 and end of the coupling bag 1100 can surround the front and rear of the footrest 830 to couple the coupling bag 1100 and associated pad body 105 to the recliner 800, which can be desirable in various examples to allow the coupling bag 1100 and associated pad body 105 to remain coupled to the footrest 830 when the footrest 830 is in a retracted position (see e.g., FIG. 10a) and in an extended position (see e.g., FIG. 10b).

In various embodiments, the coupling loops 1140 can have a thickness such that the coupling loops 1140 can extend through a slot 832 defined by body 820 of the recliner 800 (e.g., defined by the footrest 830 and arms 822 of the recliner) such that the coupling bag 1100 and associated pad body 105 can remain coupled to the footrest 830 when the footrest 830 is in a retracted position and in an extended position. This can be desirable to allow a user to maintain normal use of the recliner 800 while the coupling bag 1100 and associated pad body 105 are coupled to the recliner 800.

In various embodiments, a coupling bag 1100 and associated pad body 105 can be coupled to a footrest 830 in various suitable ways, including adhesive-backed Velcro strips, elastic straps with snap buttons that wrap around the footrest, metal or plastic snap-on clips that grip the edge(s) of the footrest 830, elastic corner pockets that stretch over the ends of the footrest 830, drawstring channels that cinch around the perimeter of the footrest 830, neodymium magnets sewn into the pad corners with metal plates on the footrest 830, upholstery staples or tacks, fabric ties or ribbons that loop through grommets and tie underneath the footrest 830, adjustable elastic straps with buckles, metal spring clips, rubber grip strips with adhesive backing, double-sided mounting tape, zip ties through reinforced holes that can be trimmed, furniture-grade hook-and-loop tape designed for upholstery, button studs with reinforced buttonholes sewn into the coupling bag 1100, and the like. Accordingly, the examples shown and described herein should not be construed to be limiting.

Returning to the example embodiment 1100B of FIG. 12, the coupling bag 1100 can further comprise a first and second anchor strap 1160A, 1160B, which in some examples can be coupled in the center of opposing lateral edges of the coupling bag 1100 along a common axis that is perpendicular to the main axis of the coupling bag 1100 and the peripheral edges. As shown in the example of FIG. 13c, in some embodiments an anchor strap 1160 can comprise an anchor loop 1164 (e.g., made of webbing, rope, elastic, or the like), which is coupled to the edge of the coupling bag 1100 with the anchor loop 1164 extending through an anchor 1162.

In various embodiments the anchor 1162 can comprise a cylinder having a rigid core with a textured outer coating, which can comprise various suitable materials such as rubber, silicone, or the like. As shown in the example of FIG. 13c, in some embodiments, the anchor strap 1160 can extend from an edge of the coupling bag 1100 along an anchor loop axis A, which can be perpendicular to an edge axis E of the edge of the coupling bag 1100. In some embodiments, the coupling bag 1100 can comprise a first and second anchor strap 1160A, 1160B that extend from opposing edges of the coupling bag along a common loop axis A.

In various embodiments, one or more anchor straps 1160 can be configured to couple a coupling bag 1100 and associated pad body 105 to a bed 700, recliner 800, or the like. For example, as shown in FIGS. 10a and 10b, a recliner 800 can comprise one or more cushions 810 that define one or more slots 840 between the one or more cushions 810 and the body 820 of the recliner 800 and a pair of anchor straps 1160A, 1160B can be configured to be inserted into and held within the slots 840, held under the cushion 810, or the like. For example, the coupling bag 1100 can be placed on the one or more cushions 810 and the anchors 1162 of the anchor straps 1160A, 1160B can be inserted into slots 840 on opposing sides of a cushion 810, where the size and/or friction of the anchor 1162 holds the anchor 1162 in place between the cushion 810 and body 820 of the recliner (e.g., between the arm 822 and side of the cushion 810, between the recliner body 820 and bottom of the cushion, between the cushion 810 and back 824 of the body 820, or the like).

Some such embodiments can be desirable to couple a coupling bag 1100 and associated pad body 105 to a recliner 800 such that the coupling bag 1100 and associated pad body 105 do not shift or move when coupled to the recliner 800; so the coupling bag 1100 and associated pad body 105 remain substantially engaged against a base and back cushion 810A, 810B by creating a bend in the coupling bag 1100 and associated pad body 105 that follows the contour of the recliner 800 (e.g., even as the pad body 105 inflates and deflates); to create a method for quickly coupling and de-coupling the coupling bag 1100 and associated pad body 105 with the recliner 800; and the like.

In various embodiments, one or more end coupling straps 1120 and/or peripheral coupling straps 1125 can be disposed at a suitable angle to improve coupling of the coupling bag 1100 and associated pad body 105 to the recliner 800. For example, as shown in the example of FIG. 13a, in some embodiments, an angle θ between the linear edge axis E and peripheral coupling axis PC can be 25 degrees or between 20-30 degrees or between 15-35 degrees toward an end of the coupling bag 1100 with end coupling tabs 1120 can be desirable for coupling the coupling bag 1100 and associated pad body 105 to a recliner 800. Accordingly, the angle θ between the linear edge axis E and peripheral coupling axis PC in various embodiments is not a simple design choice and can be specifically configured for coupling to a recliner 800 or other article.

In another example as shown in FIG. 13b, in some embodiments, an angle between the linear edge axis E and end coupling axis EC can be 90 degrees or between +/−85 degrees or between +/−80 degrees, which can be desirable for coupling the coupling bag 1100 and associated pad body 105 to a recliner 800. Accordingly, the angle between the linear edge axis E and end coupling axis EC in various embodiments is not a simple design choice and can be specifically configured for coupling to a recliner 800 or other article.

In some embodiments, one or more anchor straps 1160 can be used to couple a coupling bag 1100 and associated pad body 105 to various suitable articles such as a bed 700 (e.g., between a mattress frame and the side and/or bottom of a mattress, or the like), so the present examples should not be construed to be limiting. Additionally, while some embodiments can include an anchor strap 1160 as discussed herein, various other suitable methods or structures can be used to couple a coupling bag 1100 and associated pad body 105 to an article or location including elastic corner pockets that wrap around the cushions; permanent mounting brackets screwed or bolted to the furniture frame; high-strength magnets embedded in the pad with corresponding metal plates attached or associated with the furniture; hook-and-loop fastener strips mounted along the edges of both the pad and furniture; adjustable webbing straps that wrap completely around the furniture piece; snap-fit plastic clips that grip the edges of cushions or frame; drawstring channels built into the pad edges that cinch around cushions; suction cups attached to non-porous surfaces; button snaps with one side permanently mounted to the furniture; quick-release buckle assemblies with straps that thread between cushions; elastic straps with alligator clips that grip the furniture upholstery; rigid plastic or metal hooks that slide between cushions and frame; toggle-style buttons that insert through reinforced loops; spring-loaded clamps that grip the furniture frame or edges; integrated sleeves or pockets in the pad that slide over cushions or frame components; upholstery zippers with one side permanently attached to the furniture; a rope with a knot in it, and the like.

Also, while an anchor 1162 can be a cylinder in some embodiments, in further embodiments an anchor 1162 can include a tapered cone or wedge shape that gets wider as it is inserted for better grip; a flat rectangular plate or bar that distributes force across a larger area; a T-shaped or L-shaped profile that hooks behind the cushion; a spherical ball shape that allows some rotation while staying secure; an hourglass or dumbbell shape with wider ends and a narrow middle; a curved or crescent shape that follows furniture contours; a pyramidal shape with multiple faces for grip; a star or cross-shaped profile for increased surface contact; an arrow or arrowhead shape that widens after insertion; an S-shaped curve that provides multiple contact points; a mushroom-shaped head with a wider top portion; a zigzag or wave pattern that increases friction; a hollow tube with compressible walls that expand after insertion; a forked or Y-shaped end that splits for better grip; an expandable umbrella-like shape that opens wider after insertion; or the like.

While some embodiments include a coupling bag 1100 configured to hold a pad body 105 that can allow the pad body 105 of the alternating pressure pad 100 to be coupled to a bed 700, recliner 800, or the like, in some embodiments, such a coupling bag 1100 can be absent or optional for coupling the pad body 105 of the alternating pressure pad 100 to a bed 700, recliner 800, or the like.

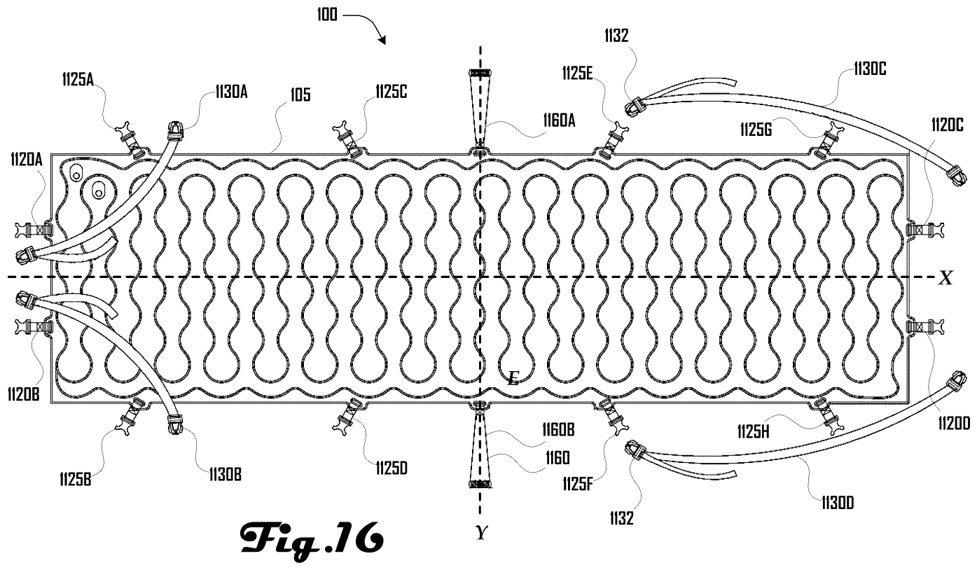

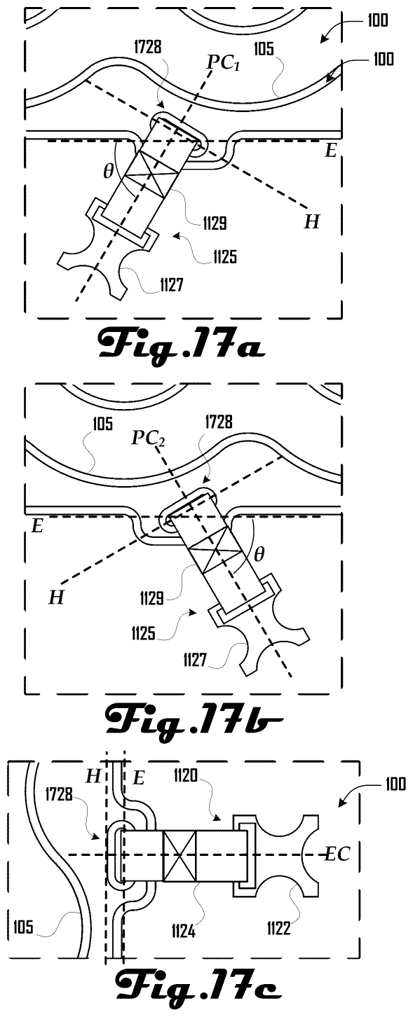

For example, FIG. 16 illustrates an example embodiment where the pad body 105 of the alternating pressure pad 100 comprises a first pair of end coupling tabs 1120A, 1120B on a first end of the coupling bag 1100 and a second pair of end coupling tabs 1120C, 1120D on a second end of the coupling bag 1100 that is opposite the first end. In various embodiments, one or more of the end coupling tabs 1120 can include a socket portion of a side-squeeze buckle assembly. The pad body 105 of FIG. 16 further comprises first, second, third, fourth, fifth, sixth, seventh and eighth peripheral coupling tabs 1125A, 1125B, 1125C, 1125D, 1125E, 1125F, 1125G, 1125H and first, second, third, and fourth coupling straps 1130A, 1130B, 1130C, 1130D that respectively couple one of the peripheral coupling tabs 1125 to one of the end tabs 1120; that respectively couple one of the peripheral coupling tabs 1125 to another one of the peripheral coupling tabs 1125; that respectively couple one of the end tabs 1120 to another one of the end tabs 1120, or the like. For example, as shown in FIG. 16, both ends of the coupling straps 1130 can include plug portions 1132 of a side-squeeze buckle assembly that respectively couple with respective socket portions 1122, 1127 of a peripheral coupling strap 1125 and an end coupling strap 1130 (see e.g., FIGS. 17a, 17b and 17c).

In various embodiments, the end coupling tabs 1120 and peripheral coupling tabs 1125 can be oriented in various suitable ways. For example, FIG. 13a illustrates an example of a peripheral coupling tab 1125 that is coupled to an edge of the coupling bag 1100 at an angle of +60 degrees. Specifically, the coupling bag 1100 has a linear edge axis E and the peripheral coupling tab 1125 defines a peripheral coupling axis PC₁ that can be defined by the peripheral coupling strap 1129 and/or socket 1127. In this example embodiment, the angle θ between the linear edge axis E and peripheral coupling axis PC is +60 degrees; however, in further embodiments, the angle θ between the linear edge axis E and peripheral coupling axis PC can be +/−5, 10, 15, 20, 25, 30, 35, 40, 45, 50, 55, 60, 65, 70, 75, 80, 85 or 90 degrees, or the like, or a range between such example values.

FIG. 13b illustrates another example of a peripheral coupling tab 1125 that is coupled to an edge of the coupling bag 1100 at an angle of −60 degrees. Specifically, the coupling bag 1100 has a linear edge axis E and the peripheral coupling tab 1125 defines a peripheral coupling axis PC₂ that can be defined by the peripheral coupling strap 1129 and/or socket 1127. In this example embodiment, the angle θ between the linear edge axis E and peripheral coupling axis PC is −60 degrees; however, in further embodiments, the angle θ between the linear edge axis E and peripheral coupling axis PC can be +/−5, 10, 15, 20, 25, 30, 35, 40, 45, 50, 55, 60, 65, 70, 75, 80, 85 or 90 degrees, or the like, or a range between such example values.

In various embodiments, a peripheral coupling tab 1125 can be disposed at such an angle in various suitable ways. For example, FIGS. 17a and 17b illustrate an example where the pad body 105 defines a coupling hole 1728 having a hole axis H through which the peripheral coupling strap 1129 loops to couple the peripheral coupling tab 1125 to the pad body 105. In various embodiments, the hole axis H is perpendicular to the peripheral coupling axis PC of the peripheral coupling tab 1125, which disposes the peripheral coupling tab 1125 (e.g., at +/−60 degrees) relative to the linear edge axis E. However, in further embodiments, the peripheral coupling tab 1125 can be disposed relative to the linear edge axis E in various suitable ways such as sewn-in reinforced fabric loops that allow straps to pass through; metal or plastic grommets installed in a pad body 105 or coupling bag 1100 for secure attachment points; bartacked webbing loops directly integrated into the edge(s) of the pad body 105 or coupling bag 1100; metal D-rings or triangular rings sewn into reinforced patches; snap buttons with reinforced backing; quick-release plastic or metal buckles attached to the pad body 105 or coupling bag 1100; strong adhesive-backed hook and loop patches; button snaps with reinforced bases; metal or plastic carabiner attachment points; adjustable ladder lock buckles sewn into the edge(s) of the pad body 105 or coupling bag 1100; zipper attachments with reinforced stitching; metal or plastic swivel hook mounts; reinforced button holes with corresponding studs; durable paracord loops with metal or plastic core; spring-gate hook attachment points sewn into reinforced zones; metal or plastic G-hook compatible loops; industrial strength magnetic snap attachments; and the like.

In some embodiments, an angle θ between the linear edge axis E and peripheral coupling axis PC can be +/−60 degrees or between 55-65 degrees or between 50-70 degrees or between 20-65 degrees or 15-70 degrees toward one of the ends of the pad body 105, which can be desirable for coupling the pad body 105 and associated pad body 105 to articles such as a bed 700, recliner 800, or the like, as discussed in more detail herein. For example, FIG. 16 illustrates an example where the first, second, third and fourth peripheral coupling tabs 1125A, 1125B, 1125C, 1125D are disposed at an angle of +60 degrees and the fifth, sixth, seventh and eight peripheral coupling tabs 1125E, 1125F, 1125G, 1125H are disposed at an angle of −60 degrees.

Turning to FIG. 17c, an example of an end coupling tab 1120 is illustrated that is coupled to an edge of a pad body 105 at an angle of 90 degrees. Specifically, the pad body 105 has a linear edge axis E and the end coupling tab 1120 defines an end coupling axis EC that can be defined by the end coupling strap 1124 and/or plug 1122. In this example embodiment, the angle between the linear edge axis E and end coupling axis EC is 90 degrees; however, in further embodiments, the angle between the linear edge axis E and end coupling axis EC can be +/−5, 10, 15, 20, 25, 30, 35, 40, 45, 50, 55, 60, 65, 70, 75, 80, 85 or 90 degrees, or the like, or a range between such example values.

In some embodiments, an angle between the linear edge axis E and end coupling axis EC can be 90 degrees or between +/−85 degrees or between +/−80 degrees, which can be desirable for coupling the coupling bag 1100 and associated pad body 105 to articles such as a bed 700, recliner 800, or the like, as discussed in more detail herein. An end coupling tab 1120 can be coupled to and oriented relative to an edge axis E of a pad body 105 and/or coupling bag 1100 in various suitable ways such as those described above related to a peripheral coupling tab 1125.

In various embodiments, it can be desirable for the ends of the coupling straps 1130 to have the same type of coupler (e.g., plug portions 1132 of a side-squeeze buckle assembly) and for the end and peripheral coupling tabs 1120, 1125 to have the same complementary type of coupler (e.g., socket portions 1122, 1127 of a side-squeeze buckle assembly) so that one or more coupling straps 1130 can be coupled to the end and peripheral coupling tabs 1120, 1125 in a plurality of suitable configurations. For example, FIG. 16 illustrates a first, second, third and fourth coupling strap 1130A, 1130B, 1130C, 1130D that can be coupled to any suitable combination of peripheral coupling tabs 1125A, 1125B, 1125C, 1125D, 1125E, 1125F, 1125G, 1125H and/or end coupling tabs 1120A, 1120B, 1120C, 1120D.

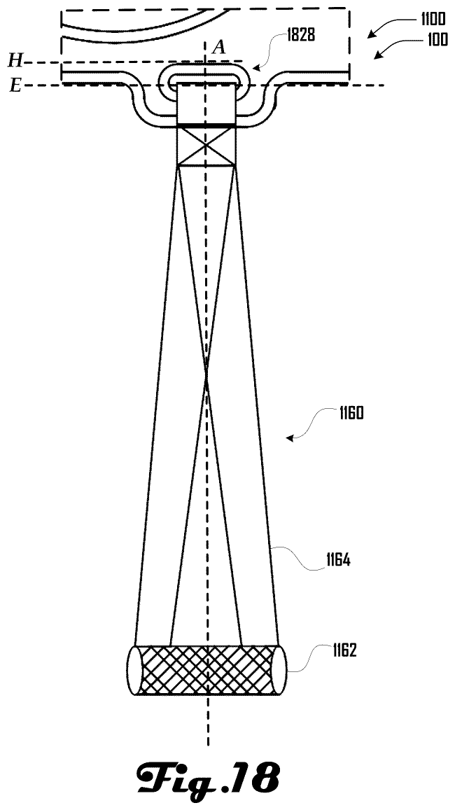

As shown in the example of FIG. 16, the pad body 105 can further comprise a first and second anchor strap 1160A, 1160B, which in some examples can be coupled in the center of opposing lateral edges of the pad body 105 along a common axis Y that is perpendicular to the main axis of the pad body 105 and the peripheral edges. As shown in the example of FIG. 18, in some embodiments an anchor strap 1160 can comprise an anchor loop 1164 (e.g., made of webbing, rope, elastic, or the like), which is coupled to the edge of the pad body 105 with the anchor loop 1164 extending through an anchor hole 1828 defined by the pad body 105.

In various embodiments, the anchor 1162 can comprise a cylinder having a rigid core with a textured outer coating, which can comprise various suitable materials such as rubber, silicone, or the like. As shown in the example of FIG. 18, in some embodiments, the anchor strap 1160 can extend from an edge of the pad body 105 along an anchor loop axis A, which can be perpendicular to an edge axis E of the edge of the coupling bag 1100 and a coupling hole axis H of a coupling hole 1828. In some embodiments, the pad body 105 can comprise a first and second anchor strap 1160A, 1160B that extend from opposing edges of the coupling bag along a common loop axis Y. In various embodiments, one or more anchor straps 1160 can be configured to couple a pad body 105 to a bed 700, recliner 800, or the like as described herein.

While some examples shown herein include first and second anchor straps 1160A, 1160B, further embodiments can include any suitable number of anchor straps 1160 such as 0, 1, 2, 3, 4, 5, 6, 7, 8, 9, 10, 12, 15, 20, 25, 50, or the like or a range between such examples values. Additionally, various embodiments can have any suitable number of end coupling tabs 1120 and peripheral coupling tabs 1125 such as 0, 1, 2, 3, 4, 5, 6, 7, 8, 9, 10, 12, 15, 20, 25, 50, or the like or a range between such examples values.

In some preferred embodiments, one or more anchor straps 1160 can have a length of 9 inches or a range between 8 and 10 inches. In various embodiments, such a length can be specifically configured for suitable coupling with a bed 700 and/or recliner 800, so such a length is not simply an obvious design choice. In further embodiments, one or more anchor straps 1160 can have a length of 1, 2, 3, 4, 5, 6, 7, 8, 9, 10, 11 12, 13, 14 inches, or the like, or a range between such example values.

In some preferred embodiments, anchors 1162 can have a diameter of 1.25 inches or a range between 0.75 inches and 1.50 inches. In various embodiments, such a diameter can be specifically configured for suitable coupling with a bed 700 and/or recliner 800, so such a diameter is not simply an obvious design choice. In further embodiments, one or more anchors 1162 can have a diameter or width of 0.25, 0.5, 0.75, 1.0, 1.25, 1.5, 1.75, 2.0, 2.25 inches, or the like, or a range between such example values.

In some preferred embodiments, anchors 1162 can have a width of 2 inches or a range between 1.5 inches and 2.50 inches. In various embodiments, such a width can be specifically configured for suitable coupling with a bed 700 and/or recliner 800, so such a width is not simply an obvious design choice. In further embodiments, one or more anchors 1162 can have a diameter or width of 0.5, 0.75, 1.0, 1.25, 1.5, 1.75, 2.0, 2.25, 2.5, 2.75, 3.0, 3.5, 4.0 inches, or the like, or a range between such example values.

In some preferred embodiments, straps 1124 of end coupling tabs 1120 can have a length of 2.75 or 1.25 inches or a range between 1.0 inches and 3.0 inches. In various embodiments, such a length can be specifically configured for suitable coupling with a bed 700 and/or recliner 800, so such a length is not simply an obvious design choice. In further embodiments, one or more straps 1124 of end coupling tabs 1120 can have a length of 0.5, 0.75, 1.0, 1.25, 1.5, 1.75, 2.0, 2.25, 2.5, 2.75, 3.0, 3.5, 4.0, 5.0, 10.0 inches, or the like, or a range between such example values.

In some preferred embodiments, straps 1129 of peripheral coupling tabs 1125 can have a maximum length of 2.75 or 4.0 inches or a range between 2.5 inches and 5.0 inches. In various embodiments, such a length can be specifically configured for suitable coupling with a bed 700 and/or recliner 800, so such a length is not simply an obvious design choice. In further embodiments, one or more straps 1124 of peripheral coupling tabs 1125 can have a maximum length of 1.0, 1.25, 1.5, 1.75, 2.0, 2.25, 2.5, 2.75, 3.0, 3.5, 4.0, 5.0, 6.0, 7.0, 8.0, 9.0, 10.0 inches, or the like, or a range between such example values.

In some preferred embodiments, one or more coupling straps 1130 can have a maximum strap 1134 length of 42.5 inches or a range between 40 inches and 45 inches. In some preferred embodiments, one or more coupling straps 1130 can have a maximum strap 1134 length of 20.5 inches or a range between 18.5 inches and 22.5 inches. In various embodiments, such a length can be specifically configured for suitable coupling with a bed 700 and/or recliner 800, so such a length is not simply an obvious design choice. In further embodiments, one or more coupling loops 1140 can have a maximum strap 1134 length of 8.0, 9.0, 10.0, 11.0, 12.0, 13.0, 14.0, 15.0, 16.0, 17.0, 18.0, 19.0, 20.0, 21.0, 22.0, 23.0, 24.0, 25.0, 30.0, 35.0, 40.0, 45.0, 50.0, 55.0 inches, or the like, or a range between such example values.

In various embodiments, one or more coupling straps 1130 can be inextensible (e.g., made of webbing), elastic (e.g., make of an elastic strap), or the like. In various embodiments, one or more coupling straps 1130 can be of a fixed size or a variable size. In some preferred embodiments, some of the coupling straps 1130 (e.g., two) can be elastic with a maximum length of 20.5 inches or a range between 18.5 inches and 22.5 inches. In some preferred embodiments, some of the coupling straps 1130 (e.g., two) can be inextensible with a maximum length of 42.5 inches or a range between 40 inches and 45 inches.

In some embodiments, where an alternating pressure pad 100 comprises a plurality of coupling straps 1130, it can be desirable for some of the straps to be different sizes and/or different extensibilities based on what the coupling straps 1130 are configured to couple with. For example, one embodiment can include two inextensible coupling straps 1130 with a maximum length of 42.5 inches or a range between 40 inches and 45 inches configured to couple with a back 824 of a recliner 800 (see e.g., third and fourth coupling straps 1130C, 1130D of FIG. 16 and/or coupling straps 1130 in FIG. 15) and two elastic coupling straps with a maximum length of 20.5 inches or a range between 18.5 inches and 22.5 inches configured to couple with a footrest of a recliner 800 (see e.g., first and second coupling straps 1130A, 1130B of FIG. 16).

Coupling straps 1130 of further embodiments can be various suitable lengths and extensibilities and configured for coupling to various suitable articles (e.g., a bed 700) as discussed herein. For example, in some embodiments, coupling straps 1130 can be configured to surround the mattress 710 of a bed 700; configured to surround one or more corners of a mattress 710 of a bed 700; configured to surround a bed frame 720 and mattress 710 of a bed 700; configured to couple with a frame 720 of a bed 700; or the like. In some embodiments, one or more coupling straps 1130 can define one or more coupling loops 1140 (e.g., extending between an end coupling tab 1120 and a peripheral coupling tab 1125), which in some examples can be configured to couple with a footrest 830 of a recliner 800 as discussed herein.

In some embodiments an alternating pressure pad 100 can be coupled to various articles include wrapping 1130 and/or 1140 around a massage table's frame and padding; securing to an airplane seat back and bottom cushion; attaching to exam table rails and cushions; fastening around a dentist chair's adjustable sections; securing to bleacher seats; anchoring to stadium seat backs and bottoms; coupling to or around workout bench padding and/or frame; attaching to medical examination chairs; and the like.

In some preferred embodiments, coupling loops 1140 can have a maximum length of 13 inches or a range between 12 inches and 14 inches. In various embodiments, such a length can be specifically configured for suitable coupling with a bed 700 and/or recliner 800, so such a length is not simply an obvious design choice. In further embodiments, one or more coupling loops 1140 can have a maximum length of 8.0, 9.0, 10.0, 11.0, 12.0, 13.0, 14.0, 15.0, 16.0, 17.0, 18.0 inches, or the like, or a range between such example values.

Various embodiments include a method of coupling a pressure pad system 600 to an article (e.g., a bed 700, recliner 800 or the like). Such a method can include disposing a pad body 105 of the pressure pad system 600 on at least one cushion 810 or mattress 710 of the article (e.g., within a coupling bag 1100, without a coupling bag 1100, directly on the at least one cushion 810 or mattress 710, or the like). In various examples, the pad body 105 can have a rectangular shape with a length axis that is greater than a width axis. In various embodiments, the pressure pad system 600 can have first and second ends and parallel first and second peripheral sides (e.g., defined by a coupling bag 1100 and/or pad body 105).

In various embodiments, the pad body 105 of the pressure pad system 600 can comprise a first layer defined by a first planer sheet of polyvinyl chloride (PVC) of the pad body, the first layer having a thickness of between 0.29 mm-0.70 mm; a second layer defined by a second planer sheet of PVC of the pad body, the second layer having a thickness between 0.29 mm-0.70 mm, the second layer being directly physically coupled with the first layer via a plurality of weld couplings; a first chamber and a second chamber that is separate from the first chamber, the first and second chambers being defined by the first and second layers and the plurality of weld couplings that physically couple the first and second layers, the first and second chambers being physically separate such that the first and second chambers can be separately inflated and deflated, the first and second chambers defining a plurality of first and second forks that are staggered with each other, with each of the plurality of first and second forks having a central fork axis that is parallel to the width axis of the pad body and perpendicular to the length axis of the pad body; a first charging port and a second charging port, the first charging port defining a passage through which air can be introduced into the first chamber and the second charging port defining a passage through which air can be introduced into the second chamber, the first charging port and the second charging port being separate such that the first and second chambers can be separately inflated and deflated via the first charging port and the second charging port; a plurality of end coupling tabs extending from one or both of the first and second ends of the pressure pad system, with at least two end coupling tabs extending from one of the first and second ends of the pressure pad system and with each of the end coupling tabs comprising an end coupling strap and a socket portion of a side-squeeze buckle assembly coupled to the end coupling strap; a plurality of peripheral coupling tabs coupled to the first and second peripheral sides, with at least one peripheral coupling tab coupled to each of the first and second peripheral sides and with each of the plurality of peripheral coupling tabs comprising a peripheral coupling strap and a socket portion of a side-squeeze buckle assembly; a plurality of coupling straps comprising a strap with plug portions of a side-squeeze buckle assembly on opposing sides of the strap, with each of the plug portions configured to couple with the socket portions of the end coupling tabs and the socket portions of the peripheral coupling tabs; and a plurality of anchor straps coupled centrally and respectively along a common anchor strap axis to the first and second peripheral sides via a respective anchor loop that extends through a respective anchor.

In various embodiments the method can include anchoring the pressure pad system to the article by disposing the anchors of the respective anchor straps into respective first and second slots defined by the at least one cushion or mattress of the article and a frame or body of the article and coupling the pressure pad system to the article including wrapping at least two of the plurality of coupling straps around the frame or body of the article and the at least one cushion or mattress of the article with the at least two of the plurality of coupling straps crisscrossing.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

### EXAMPLES

Puncture tests were performed on different flocked and non-flocked PVC sheets of different thicknesses. The following procedure was followed for each of the tests:
(1) Cut a piece of specimen from the sample sized to fit into the serrated clamping plate with an open area 6″ diameter (˜15.24 cm); (2) Clamp the specimen on the serrated clamping plate; (3) Set a force gage and a ¼″ (˜0.635 cm) diameter steel rod for puncture; (4) Push the steel rod into the specimen at a constant rate 1 inch/minute (˜2.54 cm/min.); (5) Measure the force used to puncture through the specimen in lbf (lbf=pound−force, which is approximately equal to 4.44822 newtons); (6) Observe and record all findings or any other unusual changes; and (7) Repeat steps 1 to 5 for other specimen(s) if necessary.

A test on a flocked PVC sheet having a thickness of 0.6 mm (with 0.2 mm of a PVC sheet portion and 0.4 mm of a flocking portion) yielded the following results: Specimen #1: 31.3 lbf; Specimen #2: 29.8 lbf; Specimen #3: 30.2 lbf; Specimen #4: 30.4 lbf; Specimen #5: 30.5 lbf.

A test on a non-flocked PVC sheet having a thickness of 0.35 mm yielded the following results: Specimen #1: 25.2 lbf; Specimen #2: 26.0 lbf; Specimen #3: 24.6 lbf; Specimen #4: 25.4 lbf; Specimen #5: 25.3 lbf.

An alternating pressure pad 100 comprising first and second layer 1, 2 of the tested flocked PVC sheet having a thickness of 0.6 mm (with 0.2 mm of a PVC sheet portion and 0.4 mm of a flocking portion) and a non-flocked PVC sheet having a thickness of 0.35 mm was found to be desirable for the application of providing a flocked alternating pressure pad for bedsore prevention.

A test on a non-flocked PVC sheet having a thickness of 0.559 mm yielded the following results: Specimen #1: 40.6 lbf; Specimen #2: 39.8 lbf; Specimen #3: 39.3 lbf; Specimen #4: 39.5 lbf; Specimen #5: 39.8 lbf.

A test on a non-flocked PVC sheet having a thickness of 0.28 mm yielded the following results: Specimen #1: 17.5 lbf; Specimen #2: 17.8 lbf; Specimen #3: 17.9 lbf; Specimen #4: 17.3 lbf; Specimen #5: 18.3 lbf.

What is claimed is:

1. A method of coupling a pressure pad system to an article, the method comprising:
disposing a pad body of the pressure pad system on at least one cushion or mattress of the article, the pad body having a rectangular shape with a length axis that is greater than a width axis, the pressure pad system having parallel first and second ends and parallel first and second peripheral sides, the pressure pad system comprising:
a first layer defined by a first planer sheet of polyvinyl chloride (PVC) of the pad body, the first layer having a thickness of between 0.29 mm-0.70 mm;
a second layer defined by a second planer sheet of PVC of the pad body, the second layer having a thickness between 0.29 mm-0.70 mm, the second layer being directly physically coupled with the first layer via a plurality of weld couplings;
a first chamber and a second chamber that is separate from the first chamber, the first and second chambers being defined by the first and second layers and the plurality of weld couplings that physically couple the first and second layers, the first and second chambers being physically separate such that the first and second chambers can be separately inflated and deflated, the first and second chambers defining a plurality of first and second forks that are staggered with each other, with each of the plurality of first and second forks having a central fork axis that is parallel to the width axis of the pad body and perpendicular to the length axis of the pad body;
a first charging port and a second charging port, the first charging port defining a passage through which air can be introduced into the first chamber and the second charging port defining a passage through which air can be introduced into the second chamber, the first charging port and the second charging port being separate such that the first and second chambers can be separately inflated and deflated via the first charging port and the second charging port;
a plurality of end coupling tabs extending from one or both of the first and second ends of the pressure pad system, with at least two end coupling tabs extending from one of the first and second ends of the pressure pad system and with each of the end coupling tabs comprising an end coupling strap and a socket portion of a side-squeeze buckle assembly coupled to the end coupling strap;
a plurality of peripheral coupling tabs coupled to the first and second peripheral sides, with at least one peripheral coupling tab coupled to each of the first and second peripheral sides and with each of the plurality of peripheral coupling tabs comprising a peripheral coupling strap and a socket portion of a side-squeeze buckle assembly;
a plurality of coupling straps comprising a strap with plug portions of a side-squeeze buckle assembly on opposing sides of the strap, with each of the plug portions configured to couple with the socket portions of the end coupling tabs and the socket portions of the peripheral coupling tabs; and
a plurality of anchor straps coupled centrally and respectively along a common anchor strap axis to the first and second peripheral sides via a respective anchor loop that extends through a respective anchor;
anchoring the pressure pad system to the article by disposing the anchors of the respective anchor straps into respective first and second slots defined by the at least one cushion or mattress of the article and a frame or body of the article; and
coupling the pressure pad system to the article including wrapping at least two of the plurality of coupling straps around the frame or body of the article and the at least one cushion or mattress of the article with the at least two of the plurality of coupling straps crisscrossing.

2. The method of claim 1, wherein the article comprises a recliner that includes the at least one cushion and a footrest configured to assume a retracted configuration and an extended configuration,
wherein two of the end coupling tabs extend from the first end, and
wherein the pressure pad system comprises:
a first coupling loop extending between and coupled to the second end and the first peripheral side, and
a second coupling loop extending between and coupled to the second end and the second peripheral side, and
wherein the first coupling loop and the second coupling loop couple with the footrest of the recliner, by wrapping around the footrest, to couple the pressure pad system to the footrest of the recliner including when the footrest is in both the retracted configuration and the extended configuration.

3. The method of claim 1, wherein the pressure pad system comprises a coupling bag that defines a bag cavity in which the pad body of the pressure pad system is disposed, the coupling bag comprising a front and rear rectangular sheet with a bag zipper disposed along a central length axis of the coupling bag extending from the first end to the second end,
wherein opening the bag zipper allows the pad body to be inserted into and/or removed from the bag cavity and closing the bag zipper allows the pad body to be enclosed within the bag cavity, and
wherein the coupling bag defines the parallel first and second ends and parallel first and second peripheral sides.

4. The method of claim 1, wherein the pad body defines the parallel first and second ends and the parallel first and second peripheral sides, and wherein the plurality of end coupling tabs and plurality of peripheral coupling tabs are coupled to the pad body.

5. A method of coupling a pressure pad system to an article, the method comprising:
disposing a pad body of the pressure pad system on at least one cushion or mattress of the article, the pad body having a rectangular shape with a length axis that is greater than a width axis, the pressure pad system including first and second ends and first and second peripheral sides, the pressure pad system comprising:
a plurality of end coupling tabs extending from one or both of the first and second ends of the pressure pad system, with at least two end coupling tabs extending from one of the first and second ends of the pressure pad system and with each of the end coupling tabs comprising an end coupling strap and a socket portion coupled to the end coupling strap,
a plurality of peripheral coupling tabs coupled to the first and second peripheral sides, with at least one peripheral coupling tab coupled to each of the first and second peripheral sides and with each of the plurality of peripheral coupling tabs comprising a peripheral coupling strap and a socket portion, and
a plurality of coupling straps comprising a strap with plug portions on opposing sides of the strap, with each of the plug portions configured to couple with the socket portions of the end coupling tabs and the socket portions of the peripheral coupling tabs; and
coupling the pressure pad system to the article including wrapping at least two of the plurality of coupling straps around a frame or body of the article and the at least one cushion or mattress of the article.

6. The method of claim 5, wherein the pad body comprises:
a first layer defined by a first planer sheet of polyvinyl chloride (PVC) of the pad body, the first layer having a thickness of between 0.29 mm-0.70 mm;
a second layer defined by a second planer sheet of PVC of the pad body, the second layer having a thickness between 0.29 mm-0.70 mm, the second layer being directly physically coupled with the first layer via a plurality of weld couplings;
a first chamber and a second chamber that is separate from the first chamber, the first and second chambers being defined by the first and second layers and the plurality of weld couplings that physically couple the first and second layers, the first and second chambers being physically separate such that the first and second chambers can be separately inflated and deflated, the first and second chambers defining a plurality of first and second forks that are staggered with each other, with each of the plurality of first and second forks having a central fork axis that is parallel to the width axis of the pad body and perpendicular to the length axis of the pad body; and
a first charging port and a second charging port, the first charging port defining a passage through which air can be introduced into the first chamber and the second charging port defining a passage through which air can be introduced into the second chamber, the first charging port and the second charging port being separate such that the first and second chambers can be separately inflated and deflated via the first charging port and the second charging port.

7. The method of claim 5, wherein each of the end coupling tabs comprise a socket portion of a side-squeeze buckle assembly coupled to the end coupling strap,
wherein each of the plurality of peripheral coupling tabs comprise a socket portion of a side-squeeze buckle assembly, and
wherein the plurality of coupling straps comprise the strap with plug portions of a side-squeeze buckle assembly on opposing sides of the strap, with each of the plug portions configured to couple with the socket portions of the end coupling tabs and the socket portions of the peripheral coupling tabs.

8. The method of claim 5, wherein the pressure pad system further comprises a plurality of anchor straps coupled to the first and second peripheral sides via a respective anchor loop that extends through a respective anchor;
and wherein the method further includes anchoring the pressure pad system to the article by disposing the anchors of the respective anchor straps into respective first and second slots defined by the at least one cushion or mattress of the article and a frame or body of the article.

9. The method of claim 5, wherein the article comprises a recliner that includes the at least one cushion and a footrest configured to assume a retracted configuration and an extended configuration,
wherein two of the end coupling tabs extend from the first end, and
wherein the pressure pad system comprises:
a first coupling loop extending between and coupled to the second end and the first peripheral side, and
a second coupling loop extending between and coupled to the second end and the second peripheral side, and
wherein the first coupling loop and the second coupling loop couple with the footrest of the recliner, by wrapping around the footrest, to couple the pressure pad system to the footrest of the recliner including when the footrest is in both the retracted configuration and the extended configuration.

10. The method of claim 5, wherein the pressure pad system comprises a coupling bag that defines a bag cavity in which the pad body of the pressure pad system is disposed, the coupling bag comprising a front and rear rectangular sheet with a bag zipper disposed along a central length axis of the coupling bag extending from the first end to the second end,
wherein opening the bag zipper allows the pad body to be inserted into and/or removed from the bag cavity and closing the bag zipper allows the pad body to be enclosed within the bag cavity, and
wherein the coupling bag defines the parallel first and second ends and parallel first and second peripheral sides.

11. The method of claim 5, wherein the pad body defines the first and second ends and the first and second peripheral sides, and wherein the plurality of end coupling tabs and plurality of peripheral coupling tabs are coupled to the pad body.

12. A method of coupling a pressure pad system to an article, the method comprising:
disposing a pad body of the pressure pad system on the article, the pressure pad system including first and second ends and first and second peripheral sides, the pressure pad system comprising:
a plurality of end coupling tabs extending from one or both of the first and second ends,
a plurality of peripheral coupling tabs coupled to the first and second peripheral sides, and
a plurality of coupling straps; and
coupling the pressure pad system to the article, including wrapping at least two of the plurality of coupling straps around a portion of the article.

13. The method of claim 12, wherein disposing the pad body of the pressure pad system on the article comprises disposing the pad body of the pressure pad system on at least one cushion or mattress of the article.

14. The method of claim 12, wherein the plurality of end coupling tabs extending from one or both of the first and second ends comprises at least two end coupling tabs extending from one of the first and second ends and with each of the end coupling tabs comprising an end coupling strap and a first coupler portion attached to the end coupling strap.

15. The method of claim 12, wherein the plurality of peripheral coupling tabs coupled to the first and second peripheral sides comprises at least one peripheral coupling tab coupled to each of the first and second peripheral sides and with each of the plurality of peripheral coupling tabs comprising a peripheral coupling strap and a first coupler portion.

16. The method of claim 12, wherein the plurality of coupling straps comprise a strap with second coupler portions on opposing sides of the strap, with each of the second coupler portions configured to couple with first coupler portions of the end coupling tabs and the peripheral coupling tabs.

17. The method of claim 16, wherein coupling the pressure pad system to the article includes wrapping at least two of the plurality of coupling straps around a frame or body of the article and a cushion or mattress of the article.

18. The method of claim 12, wherein the pressure pad system further comprises a plurality of anchor straps coupled to the first and second peripheral sides;
and wherein the method further includes anchoring the pressure pad system to the article by disposing the anchors of the respective anchor straps into respective first and second slots defined by a cushion or mattress of the article and/or a frame or body of the article.

19. The method of claim 12, wherein the article comprises a footrest configured to assume a retracted configuration and an extended configuration, and
wherein the pressure pad system comprises:
a first coupling loop, and
a second coupling loop, and
wherein the first coupling loop and the second coupling loop couple with the footrest of the recliner, by wrapping around the footrest, to couple the pressure pad system to the footrest of the recliner including when the footrest is in both the retracted configuration and in the extended configuration.

20. The method of claim 12, wherein the pressure pad system comprises a coupling bag that defines a bag cavity in which the pad body of the pressure pad system is disposed, the coupling bag comprising a front and rear rectangular sheet and including a bag closure,
wherein opening the bag closure allows the pad body to be inserted into and/or removed from the bag cavity and closing the bag closure allows the pad body to be enclosed within the bag cavity.
